(19) United States
(12) Patent Application Publication
(10) Pub. No.: US 2026/0065787 A1
(43) Pub. Date: Mar. 5, 2026

(54) STREAMING IMAGE DISPLAY WITH SURROUNDING AIRCRAFT INFORMATION ANNOTATIONS FOR AN AIRCRAFT AVIONICS SYSTEM

(71) Applicant: Cirrus Design Corporation d/b/a Cirrus Aircraft, Duluth, MN (US)

(72) Inventors: Kristen Johnston, Duluth, MN (US); Vijay Venkataraman, Duluth, MN (US); Andrew Johnson, Duluth, MN (US)

(73) Assignee: Cirrus Design Corporation d/b/a Cirrus Aircraft, Duluth, MN (US)

(21) Appl. No.: 19/314,821

(22) Filed: Aug. 29, 2025

Related U.S. Application Data
(60) Provisional application No. 63/688,590, filed on Aug. 29, 2024.
(60) Provisional application No. 63/689,049, filed on Aug. 30, 2024.
(60) Provisional application No. 63/695,171, filed on Sep. 16, 2024.
(60) Provisional application No. 63/696,091, filed on Sep. 18, 2024.

(51) Int. Cl. G08G 5/23; G06V 20/17; G08G 5/21; G08G 5/26; G08G 5/55; G08G 5/72

(52) U.S. Cl. CPC G08G 5/23; G06V 20/17; G08G 5/21; G08G 5/26; G08G 5/55; G08G 5/723

(57) ABSTRACT

A method for providing a streaming display with surrounding aircraft information on an aircraft. The method includes receiving a streaming image from a camera on the aircraft, receiving navigation information representative of the location and orientation of the aircraft, and receiving surrounding aircraft information associated with each of one or more surrounding aircraft. Based upon the navigation information and the surrounding aircraft information, a location of each surrounding aircraft with respect to the streaming image is determined. A surrounding aircraft identifier for each surrounding aircraft, and a surrounding aircraft-annotated streaming image based upon the streaming image are generated. The surrounding aircraft-annotated image includes each surrounding aircraft identifier, and each surrounding aircraft identifier is at a location in the surrounding aircraft-annotated streaming image corresponding to the location of the associated surrounding aircraft. The surrounding aircraft-annotated streaming image is displayed in the aircraft.

### CROSS-REFERENCE TO RELATED APPLICATIONS

This application is a U.S. Non-Provisional Application, which claims the benefit priority to U.S. Provisional Application No. 63/688,590, filed Aug. 29, 2024, and claims the benefit priority to U.S. Provisional Application No. 63/689,049, filed Aug. 30, 2024, and claims the benefit priority to U.S. Provisional Application No. 63/695,171, filed Sep. 16, 2024, and claims the benefit priority to U.S. Provisional Application No. 63/696,091, filed Sep. 18, 2024, which are hereby incorporated herein by reference in their entireties for all purposes.

### FIELD

This disclosure relates generally to aircraft avionics and navigation systems. Embodiments includes systems and methods for displaying a live-stream image from the aircraft that is annotated with information relating to surrounding aircraft.

### BACKGROUND

Aircraft avionics and navigation systems with graphical displays, including visual displays of the aircraft's location on maps, are generally known. Certain types of navigation-related information, such as surrounding aircraft traffic are sometimes added to the graphical displays.

There remains, however, a continuing need for improved aircraft navigation systems and displays. In particular, there is a need for aircraft navigation systems and displays that enhance a pilot's ability to quickly identify and accurately assess the nature of relevant visual information in the environment surrounding the aircraft. Navigation information display systems of these types configured for use in general aviation applications would be especially desirable.

### SUMMARY

Disclosed embodiments include an aircraft navigation systems and methods, and associated displays.

One example is a method for providing a display on an aircraft. Embodiments of the method may comprise: receiving, from a camera on the aircraft, a streaming image from the aircraft; receiving navigation information representative of the location and orientation of the aircraft; receiving surrounding aircraft information associated with each of one or more surrounding aircraft; determining, based upon the navigation information and the surrounding aircraft information, a location of each of the one or more surrounding aircraft with respect to the streaming image; generating a surrounding aircraft identifier for each of the one or more surrounding aircraft; generating a surrounding aircraft-annotated streaming image based upon the streaming image and including each surrounding aircraft identifier, wherein each surrounding aircraft identifier is at a location in the surrounding aircraft-annotated streaming image corresponding to the location of the associated surrounding aircraft; and displaying the surrounding aircraft-annotated streaming image in the aircraft.

In some embodiments, the surrounding aircraft information includes one or more of (1) information received from the surrounding aircraft, optionally Automatic Dependent Surveillance—Broadcast (ADS-B) information, (2) communication information from the surrounding aircraft, (3) information generated by a sensor on the aircraft, optionally radar information, or (4) information received from a ground-based source, optionally Air Traffic Control (ATC) information.

Some embodiments may also comprise determining, based upon the surrounding aircraft information, one or more aircraft characteristics relating to one or more characteristic-associated aircraft of the one or more surrounding aircraft, wherein the one or more aircraft characteristics includes one or more aircraft characteristics from a group including ground traffic, air traffic, audio, or track; and generating the surrounding aircraft identifier for each of the one or more characteristic-associated aircraft includes generating a surrounding aircraft identifier representative of the determined aircraft characteristic. For example, receiving the surrounding aircraft information may include receiving, and presenting in the aircraft concurrently with the receipt, audio information relating to each of one or more audio-associated aircraft of the surrounding aircraft determined to have an audio characteristic, wherein the audio information optionally includes one or more of communication information from the surrounding aircraft or Air Traffic Control (ATC) information; generating the surrounding aircraft identifier for each audio-associated aircraft includes generating an audio surrounding aircraft identifier representative of the audio characteristic; and displaying the surrounding aircraft identifier for each audio-associated aircraft includes displaying the associated audio surrounding aircraft identifier concurrently with the presentation of the associated audio information. In embodiments, generating the surrounding aircraft identifier for each audio-associated aircraft includes generating a highlighted surrounding aircraft identifier during the presentation of the associated audio information.

In some embodiments, receiving the surrounding aircraft information includes receiving track information relating to a vector of motion for each of one or more track-associated aircraft of the surrounding aircraft determined to have a track characteristic; generating the surrounding aircraft identifier for each track-associated aircraft includes generating a track surrounding aircraft identifier representative of the vector of motion of the aircraft; and displaying the surrounding aircraft identifier for each track-associated aircraft includes displaying the associated track surrounding aircraft identifier.

In some embodiments, receiving the surrounding aircraft information includes receiving ground traffic information for each of one or more ground traffic-associated aircraft of the surrounding aircraft determined to have a ground traffic characteristic; generating the surrounding aircraft identifier for each ground traffic-associated aircraft includes generating a ground traffic surrounding aircraft identifier representative of the ground characteristic of the aircraft; and displaying the surrounding aircraft identifier for each ground traffic-associated aircraft includes displaying the associated ground traffic surrounding aircraft identifier.

In some embodiments, receiving the surrounding aircraft information includes receiving air traffic information for each of one or more air traffic-associated aircraft of the surrounding aircraft determined to have an air traffic characteristic; generating the surrounding aircraft identifier for each air traffic-associated aircraft includes generating an air traffic surrounding aircraft identifier representative of the air traffic characteristic of the aircraft; and displaying the surrounding aircraft identifier for each air traffic-associated aircraft includes displaying the associated air traffic surrounding aircraft identifier.

In some embodiments, the method also comprises determining, based upon the navigation information and the surrounding aircraft information, a limited set of surrounding aircraft for identification; and displaying the surrounding aircraft identifier includes displaying the surrounding aircraft identifier for only the surrounding aircraft in the limited set of surrounding aircraft. For example, determining the limited set of surrounding aircraft for identification may include determining the limited set of aircraft based upon one or both of a maximum number of surrounding aircraft or a distance of the surrounding aircraft from the aircraft.

In some embodiments, determining the location of each of the one or more surrounding aircraft includes determining that one or more of the surrounding aircraft is outside a field of view of the streaming image; and generating the surrounding aircraft-annotated streaming image includes generating the surrounding aircraft-annotated streaming image including the surrounding aircraft identifier for each of the one or more surrounding aircraft outside the field of view of the streaming image at a location in the surrounding aircraft-annotated streaming image, optionally a side of the surrounding aircraft-annotated streaming image.

In some embodiments, determining the location of each of the one or more surrounding aircraft includes determining that at least one of the surrounding aircraft is within a field of view of the streaming image; and generating the surrounding aircraft-annotated streaming image includes generating the surrounding aircraft-annotated streaming image including the surrounding aircraft identifier for each of the at least one surrounding aircraft within the field of view at the location of the associated surrounding aircraft in the surrounding aircraft-annotated streaming image.

In some embodiments, the surrounding aircraft identifier includes one or more of (1) aircraft call sign, (2) a feature circumscribing all or part of the aircraft, (3) a feature defining aircraft intention, (4) a feature defining a track or direction, (5) aircraft velocity, (6) a feature indicating an on-ground nature, (7) a feature indicating an in-flight nature, (8) a feature indicating that the aircraft is engaged in audio communications, (9) a text box including aircraft intention, (10) relative altitude between the ownship aircraft and traffic, or (11) distance to the traffic.

Some embodiments also comprise generating, based upon the streaming image, a zoomed-in streaming image of a portion of the streaming image including one or more of the surrounding aircraft; generating a surrounding aircraft-annotated zoomed-in streaming image including each surrounding aircraft within a field of view of the surrounding aircraft-annotated zoomed-in streaming image at a location in the surrounding aircraft-annotated zoomed-in streaming image corresponding to a location of the associated surrounding aircraft; and displaying the surrounding aircraft-annotated zoomed-in streaming image. For example, displaying the surrounding aircraft-annotated zoomed-in streaming image may include displaying the surrounding aircraft-annotated zoomed-in streaming image as a picture in picture in the displayed surrounding aircraft-annotated streaming image.

In some embodiments, receiving the navigation information includes receiving the navigation information from one or both of a GPS receiver or an IMU on the aircraft.

In some embodiments, receiving the streaming image includes receiving a streaming image of a field of view in front of a cockpit of the aircraft. For example, receiving the streaming image may include receiving the streaming image includes receiving a streaming image from one or more of out the back of the aircraft (e.g., from 6:00), from the left wing of the aircraft (e.g., from 9:00) or from the right wing of the aircraft (e.g., from 3:00). In embodiments, displaying the surrounding aircraft-annotated streaming image may include displaying the surrounding aircraft-annotated streaming image on a visual display in a cockpit of the aircraft.

A second example is a computer system including one or more processors and memory storing instructions that, when executed by the processors, causes the processors to perform the methods of any one or more of the embodiments of the first example.

A third example is an aircraft including a computer system in accordance with any or all embodiments of the second example.

A fourth example is a non-transitory, computer-readable medium storing instructions that, when executed by one or more processors, causes the processors to perform the methods of any one or more of the embodiments of the first example.

### BRIEF DESCRIPTION OF THE DRAWINGS

FIG. 1 is a diagrammatic illustration of an aviation environment with aircraft that can include navigation and display systems in accordance with embodiments.

FIG. 2 is a diagrammatic illustration of a communication system in accordance with embodiments.

FIG. 3 is a diagrammatic illustration of an avionics system including a navigation and display system in accordance with embodiments.

FIG. 4 is a detailed diagrammatic illustration of functional components of a navigation and display system processing component and associated storage component, in accordance with embodiments.

FIGS. 5-14 are exemplary images from live streaming images including navigation information annotations in accordance with embodiments.

FIG. 15 is a diagrammatic illustration of a method for generating streaming image displays with navigation information annotations, in accordance with embodiments.

FIG. 16 is a diagrammatic illustration of a user interface in accordance with embodiments.

FIGS. 17-25 are exemplary images from live streaming images including surrounding aircraft information annotations, in accordance with embodiments.

FIG. 26 is a diagrammatic illustration of a method for generating streaming image displays with surrounding aircraft information annotations, in accordance with embodiments.

FIG. 27 is an exemplary image from a live streaming image including a color-based ground feature.

FIGS. 28-29 are exemplary images from live streaming images including color-based ground feature annotations, in accordance with embodiments.

FIG. 30 is an exemplary image from a live streaming image including a color-based ground feature.

FIGS. 31-32 are exemplary images from live streaming images including color-based ground feature annotations, in accordance with embodiments.

FIG. 33 is a diagrammatic illustration of a method for generating streaming image displays with color-based ground feature annotations, in accordance with embodiments.

FIG. 34 is a diagrammatic illustration of a method for generating streaming image displays with color-based ground feature annotations, in accordance with embodiments.

FIG. 35 is a diagrammatic illustration of an exemplary briefing broadcast information element display generated in accordance with embodiments.

FIG. 36 is a diagrammatic illustration of a method for generating briefing broadcast information element displays, in accordance with embodiments.

FIG. 37 is a diagrammatic illustration of an exemplary computer system that may be configured to provide the avionics systems described herein, in accordance with embodiments.

FIG. 38 is an exemplary image from a simulated live streaming image including navigation information annotations in accordance with embodiments.

### DETAILED DESCRIPTION

### Overview

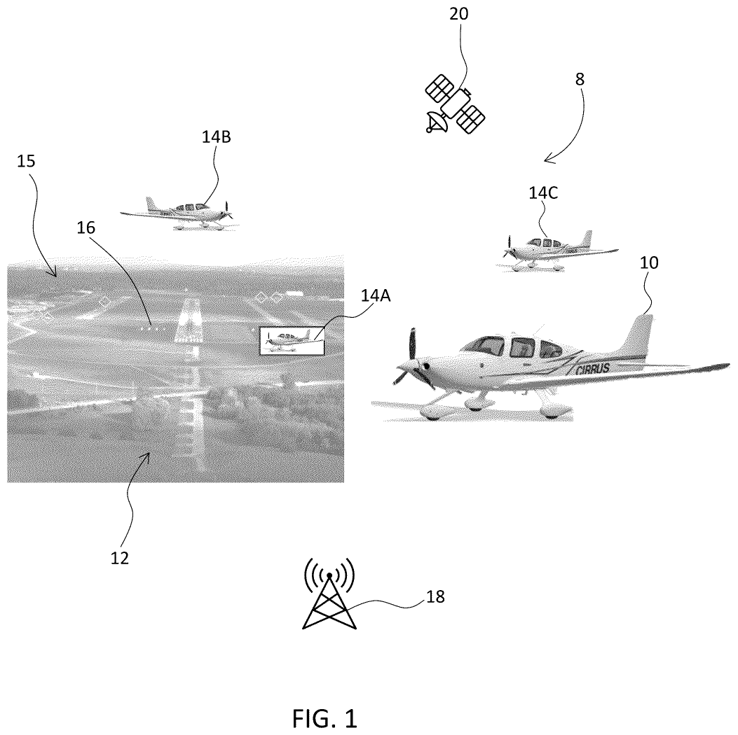

FIG. 1 is a diagrammatic illustration of an exemplary aviation environment 8 including an aircraft 10. The aircraft 10 can include avionics systems with navigation and display systems in accordance with embodiments described herein. As described in greater detail below, embodiments of the navigation and display systems include (1) live streaming image displays of fields of view (FOV) in front of the aircraft cockpit with navigation information annotations, (2) live streaming image displays of FOV with surrounding aircraft information annotations, (3) live streaming image displays of FOV with ground feature color information annotations, and (4) automated text-form displays of information elements from audio broadcasts received by the aircraft 10.

As shown in FIG. 1, the aircraft 10 (also referred to as the “ownship” aircraft) is in flight, and approaching an airport 12. Other surrounding aircraft such as 14A-14C (collectively surrounding aircraft 14, and also referred to as “traffic”), are also present in the environment 8. For purposes of example, surrounding aircraft 14A is shown on the ground at the airport 12 (e.g., is an on-ground aircraft), and surrounding aircraft 14B and 14C are shown in flight (e.g., are in-flight aircraft). Airports such as 12 typically include one or more navigation-related features 15 (e.g., ground features). As an example, the illustrated airport 12 includes a precision approach path indicator (PAPI) system 16. Other airport ground features include signal lights such as those than may be present on a control tower of airport, and lights that define the perimeters of runways and taxiways (not shown in FIG. 1). As described in greater detail below, aircraft 10 and surrounding aircraft 14 include avionics systems having navigation and display systems that make use of a range of different navigation data or information. Examples of such navigation information include global positioning system (GPS) information, automatic dependent surveillance-broadcast (ADS-B) information, automatic terminal information service broadcast (ATIS) information, national airspace system resource (NASR) information, automated briefing broadcasts from airports and other locations, and voice (e.g., audible) broadcasts or communications between an aircraft, one or more surrounding aircraft and/or ground control operations such as control towers via radio communications (e.g., referred to generally herein as comms). Also shown in FIG. 1 is a terrestrial or ground-based communication/information component 18 and above-ground or satellite communication/information component 20 that may provide functionality in connection with the navigation and display systems in some embodiments.

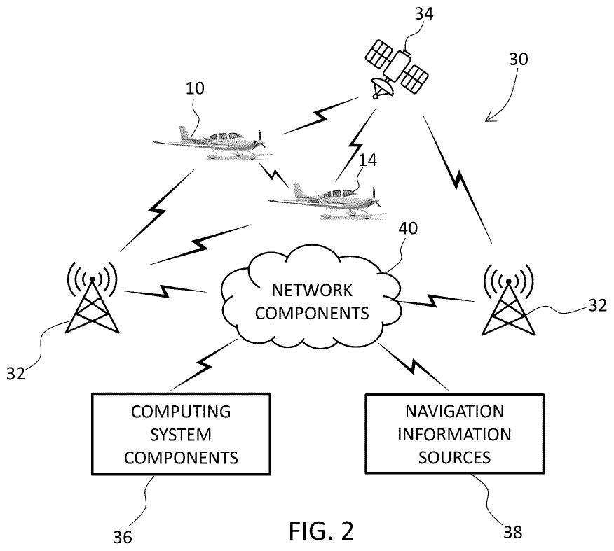

FIG. 2 is a diagrammatic illustration of a communication system 30 that can be used in the environment 8 in accordance with embodiments. The communication system 30 is configured to transmit to and receive from the aircraft 10, one or more surrounding aircraft 14, ground-based communication/information component 18 and/or satellite communication/information component 20 the data or information used in connection with the navigation and display systems of the aircraft 10 described herein. As shown, the communication system 30 includes one or more terrestrial or ground-based communication systems 32 (two are shown for purposes of example) and one or more above-ground communication systems or satellites 34 (one is shown for purposes of example) coupled to one another and to computing system components 36 and navigation information sources 38 by a network 40. Ground-based communication systems 32 are shown as functional components and include conventional or otherwise known systems, such as for example radio frequency (RF) including very high frequency (VHF), microwave or other receivers and/or transmitters to wirelessly receive data or information from, and/or to wirelessly transmit data or information to, the aircraft 10 and 14. By way of example, ground-based communication systems 32 can include air traffic control (ATC) systems at control towers of controlled airports 12, and/or the uncontrolled communications (UNICOM) systems of towerless or uncontrolled airports. As shown, embodiments of the ground-based communication systems 32 can also wirelessly transmit to and receive from satellite 34 data or information, and can be coupled to others of the ground-based communication systems 32, computing system components 36 and/or navigation information sources 38 by the network components 40 for the transmission and/or receipt of data or information. Ground-based communication systems 32 may communicate data and information directly between the aircraft 10 and/or surrounding aircraft 14 and the network 40, and/or indirectly via satellite 34. In still other embodiments, ground-based communication systems 32 provide VHF omni-directional range (VOR) functionality that can be used by the aircraft 10, 14 to determine their locations.

The satellite 34, which is also shown as a functional component, can include one or more receivers and/or transmitters to wirelessly receive and/or transmit information with respect to the aircraft 10, 14 and/or with respect to one or more ground-based communication systems 32. In embodiments, for example, satellites 34 transmit global positioning system (GPS) information used by the aircraft 10 and 14, and thereby effectively function as a navigation information source 38. Satellites 34 may also be used for the communication of other types of data or information with respect to the aircraft 10 and 14 as may be conventional or otherwise known.

Network 40 is shown as a functional component and may include one or more networks coupling the other components of the communication system 30 for data or information communication. In some embodiments, for example, the network 40 may include one or more local area networks (LAN), internet, and one or more wide area networks (WAN). The network 40 may include one or more wireless and/or wired networks.

As described below (but not shown in FIG. 2), the aircraft 10 and surrounding aircraft 14 include one or more communication devices such a radios with one or more transmitters and/or receivers. This communication devices are used to transmit and/or receive data or information with respect to other components of the communication system 30 such as the ground-based communication systems 32 and/or satellites 34, and/or directly with respect to other aircraft 10 and 14. Example of such communication devices on the aircraft 10, 14 include VHF and other radios to transmit and receive comms, and devices configured for more specific applications such as for example GPS receivers and ADS-B radios.

Navigation information sources 38 include one or more of a wide range of sources of data or information used by the navigation and display system embodiments described herein. For example, the navigation information sources 38 may include sources maintained and made available by governmental organizations such as U.S. Federal Aviation Administration (FAA), including the ATIS and NASR information, and sources of other broadcasts relating to certain airspace or airport regions, such as those of the automated weather observing system (AWOS), automated surface observing system (ASOS), and notices to airmen (NOTAM). Navigation information sources 38 may also include sources maintained and/or made available by other third parties, such as those providing weather information. Although shown as a functional component in FIG. 2, the navigation information sources 38 can include sources of information maintained at plurality of different physical (e.g., on-ground) locations. Alternatively or additionally, in embodiments information such as for example NASR information provided by the navigation information sources 38 can be provided by navigation information sources on the aircraft 10, 14 (e.g., locally-stored copies of the NASR information).

Computing system components 36, which as described below can include one or more servers or other processors and other conventional computing components, can receive requests for data and information from aircraft 10 and surrounding aircraft 14, retrieve that information from the navigation information sources 38, and cause that information to be transmitted to the aircraft 10 and 14. As described in greater detail below, in embodiments the aircraft 10 and/or surrounding aircraft 14 are configured with on-board avionics systems including computing resources to provide all or portions of the navigation and display system functionality described herein. However, in other embodiments, all or portions of the computing resources of the navigation and display systems may be provided by the computing system components 36, for example by cloud computing resources.

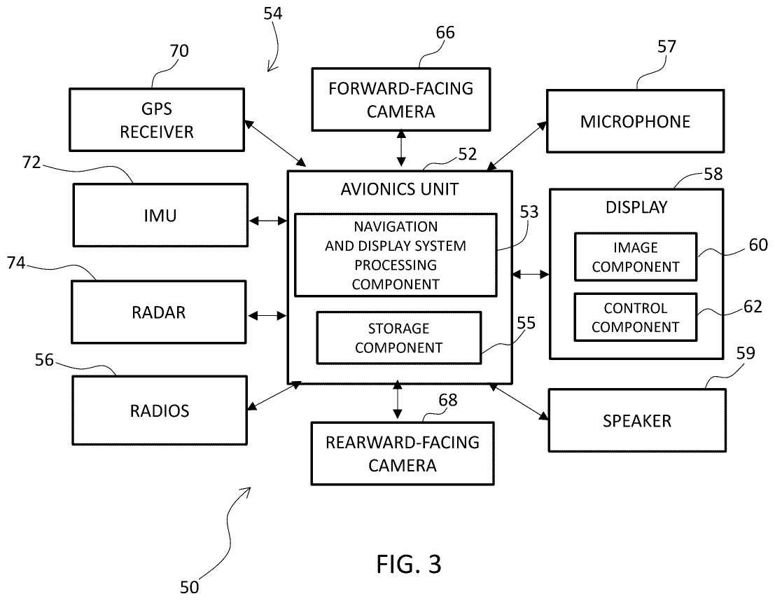

FIG. 3 is a diagrammatic illustration of an avionics system 50 that can be incorporated into the aircraft 10, 14 in accordance with embodiments. As shown, avionics system 50 includes an avionics unit 52 coupled to sensors 54, radios 56, display 58, microphone 57 and speaker 59. Avionics unit 52, which may include conventional line replaceable units (LRU) in the form of conventional avionics units commercially available from entities such as Garmin Ltd, includes a navigation and display system processing component 53 and associated storage component 55 configured to cooperate with the other components of the avionics system 50 and communication system 30 to provide computing resources for the functionality of the navigation and display systems described herein.

Display 58 includes an image component 60 and a control component 62. Image component 60 provides a graphical or visual display, including for example maps, still images, and live streaming video images of fields of view (FOV) outside of the aircraft 10. All or portions of the live streaming images with navigation information annotations, live streaming images with surrounding aircraft information annotations, live streaming images with ground feature color information annotations, and briefing broadcast information element displays of the navigation and display system embodiments, can for example be presented to the pilot by the image component 60. In embodiments, for example, the image component 60 may include one or more monitors such as an LCD (liquid crystal display) screen.

Control component 62 provides an interface by which a pilot of the aircraft 10 can interface with and control the avionics system 50, for example to provide user-selected input to the avionics system. All or portions of the briefing broadcast information element display embodiments can, for example be presented to the pilot by the control component 62. In embodiments, the control component 62 includes a graphical user interface, for example by a touch-screen display. The image component 60 and control component 62 are shown as functional components in FIG. 3, and may be provided by a common physical structure such as a touch-screen display (e.g., all or portions of control component 62 may be presented on the same display as that of the image component 60). Alternatively or additionally, all or portions of the functionality of control component 62 can be provided by systems separate from the image component 60 or display 58, for example by a dedicated touch-screen display, switches such as those of a keypad, voice commands received via the microphone 57, and/or a gesture-activated interface (not shown).

Sensors 54 include one or more video cameras such as a forward-facing camera 66 and rearward-facing camera 68, GPS receiver 70, inertial measurement unit (IMU) 72 and radar 74. The cameras such as 66 and 68 provide signals or information defining real-time streaming images (e.g., live video) of one or more FOV outside of the aircraft 10. Forward-facing camera 66, for example, which may be mounted to the nose, forward fuselage or wings of the aircraft 10, provides images of the FOV outside the front of the aircraft as seen by the pilot while looking out the windshield from the cockpit of the aircraft. Rearward-facing camera 68, for example, which may be mounted to the tail or rear fuselage of the aircraft 10, provides images of the FOV behind the aircraft. Other embodiments of avionics system 50 may include alternative and/or additional cameras, such as for example one or more cameras that provide video images of FOV upwardly, downwardly (e.g., including the undercarriage, such as landing gear, or other underside portions of the aircraft) and sideways. In effect, avionics system 50 may include cameras that provide video images of any or all FOV from the aircraft 10.

GPS receiver 70 is configured to receive data or information from the one or more satellites 34 or other sources of navigation information of the communication system 30, and to provide data or information representative of the location of the aircraft 10. In embodiments, for example, GPS receiver 70 provides geo location data or information representative of coordinates such as latitude and longitude in response to navigation information received from the satellites 34.

IMU 72 is configured to provide data or information representative of certain characteristics of the aircraft 10, such as its pose or orientation, direction of motion, altitude and speed. In embodiments, for example, IMU 72 provides information representative of orientation based on axes such as pitch, roll and yaw, and information representative of direction based on compass heading.

Radios 56 include one or more receivers and/or transmitters. Data and information such as navigation information and comms can be transmitted and received by radios 56. For example, radios 56 on the aircraft can be configured to receive the ADS-B, ATIS, AWOS, ASOS, NOTAM, VOR, NASR, and/or other information from navigation information sources 38 and/or surrounding aircraft 14. Radios 56 on the aircraft 10 can also be configured to transmit and receive comms with respect to surrounding aircraft 14, ATC systems at controlled airports and/or UNICOM communications at towerless airports. Although shown as a functional component in FIG. 3, radios 56 can include one or more separate radio units or systems, each configured to operate at one or more predetermined frequencies, or to be tuned to operate at a selected one of a plurality of frequencies. For example, radios 56 can include a dedicated system to receive ADS-B information. Audio information such as for example ATIS broadcasts received by the radios 56 can be presented to the pilot or other user by speaker 59. Microphone 57 and/or speaker 58 can be configured to receive and present sound in the cockpit are generally, and/or can be components of a headset worn by the pilot.

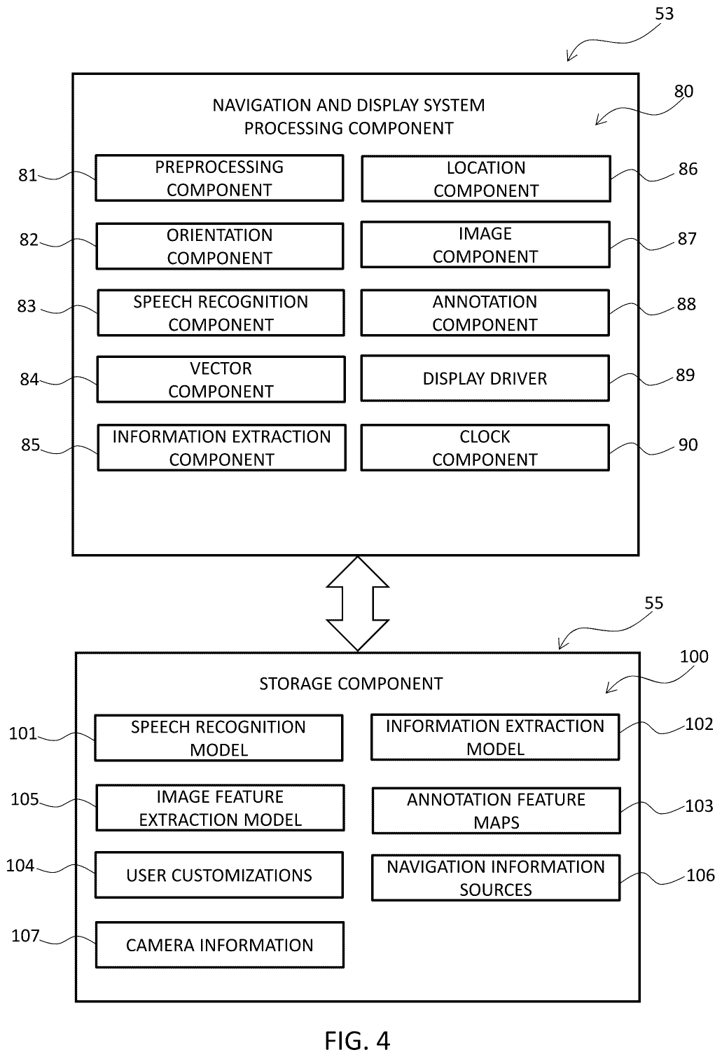

FIG. 4 is a detailed diagrammatic illustration of the navigation and display processing component 53, and its associated storage component 55 in accordance with embodiments. The navigation and display system processing component 53 includes a plurality of processing components 80, shown as functional components, that cooperate to provide the navigation and display system functionality described herein. The illustrated embodiments include preprocessing component 81, orientation component 82, speech recognition component 83, vector component 84, information extraction component 85, location component 86, image component 87, annotation component 88, display driver 89 and clock component 90.. The storage component 55 includes a plurality of stored information components 100, shown as functional components, used by the navigation and display processing component 53. The illustrated embodiments of stored information components 100 include speech recognition model 101, information extraction model 102, annotation feature maps 103, user customizations 104, image feature extraction model 105, navigation information sources 106 and camera information 107.

Preprocessing component 81 is used in embodiments to processes certain received data and information, and can for example convert that information into formats used by others of the processing components. In other embodiments described below, the preprocessing component 81 time synchronizes certain information received from components of the avionics system 50. Additionally and/or alternatively, in embodiments the preprocessing component 81 processes the images (e.g., image frames) produced by the cameras such as 66 and 68. For example, preprocessing component 81 may perform color or exposure corrections on the images, for example to compensate for poor lighting and/or weather conditions. Examples of other operations that can be performed by the preprocessing component 81 include time synchronization, for example between one or more of the video image frames, GPS information, IMU information or ADS-B information (e.g., based on timestamps), time synchronization for display of information of these types at the current time on the display 58 (e.g., a multi-function display), and/or preprocessing (e.g., filtering) of audio data before processing by the speech recognition component 83 of the navigation and display system processing component 53.

Orientation component 82 receives information from one or more of the sensors 54 of avionics system 50, such as for example from the IMU 72, and generates information representative of the orientation of the aircraft 10 based upon that received information. In embodiments, for example, orientation component 82 generates information representative of one or more of the heading (e.g., direction) of the aircraft 10, pose or orientation of the aircraft (e.g., pitch, roll and yaw), altitude, speed, and/or rates of change to these parameters.

Speech recognition component 83 receives information from the avionics system 50, such as for example audio comms via the radios 56 and/or audible commands from the pilot via the microphone 57, and converts the audio information into text form for processing by other components of the navigation and display system processing component 53. In embodiments, the speech recognition component 83 uses speech recognition model 101 of the storage component 55 to generate the information in text form. Speech recognition model 101 may be a trained model. In embodiments, for example, the speech recognition model 101 is trained using aviation terminology to enhance the accuracy and comprehensiveness by which audible information in the aviation environment 8 is converted into text form.

Information extraction component 85 receives the text form information from speech recognition component 83 and identifies or extracts relevant information, such as words, phrases, numerical values and/or other information elements to be used by other components of the navigation and display system processing component 53. In embodiments, the information extraction component 85 uses information extraction model 102 of the storage component 55 to identify and extract the relevant information elements from the text form information. Information extraction model 102 may be a trained model. In embodiments, for example, the information extraction model 102 is trained using aviation terminology to enhance the accuracy and comprehensiveness by which relevant information elements in the aviation environment 8 are extracted from the text form of the information.

Vector component 84 receives information from other components of the avionics system 50 representative of the locations, such as geo locations, of aircraft 10 and other structures and/or regions of interest, such as for example the airport 12, surrounding aircraft 14, and/or airport features 15, and generates vectors and/or other information defining the relative positions in space between the aircraft 10 and those other structures and/or regions of interest.

Vector component 84 translates the locations of different structures and/or regions of interest between the different and relevant coordinate reference systems such as the geo locations and orientations of the aircraft 10, 14, the geo locations of airports and associated ground features, and the pixel locations corresponding to structures and regions of interest such as aircraft 14, airport 12 and ground features in (and outside of) FOV in the streaming images. For example, if the structure or region of interest is an airport feature 15 or an on-ground surrounding aircraft 14 that is within the FOV, vector component 84 can determine the location of the airport feature or surrounding aircraft in the image. As another example, if the structure or region of interest is an airport 12 or an in-flight surrounding aircraft 14 that is outside the FOV of the image, vector component 84 can determine the location of the airport or surrounding aircraft with respect to the image (e.g., left of the FOV, right of the FOV, or below the FOV). Conventional or otherwise known approaches, including those sometimes referred to as “camera projection,” can be used by the vector component 84 to provide the functionality described herein.

Location component 86 receives data or information from one or more of the sensors 54 of the avionics system 50, and generates data or information representative of location of aircraft 10 and/or surrounding aircraft 14. For example, based upon information received from the GPS receiver 70, location component 86 can determine the location (e.g., geo location in terms of latitude and longitude) of the aircraft 10. In some embodiments, other location information can be obtained from other sensors 54. For example, altitude of the aircraft 10 can be determined from information provided by IMU 72 and/or an altimeter (not shown) on the aircraft. In embodiments of aircraft 10 that include a radar 74, the location component 86 can, based upon the data or information provided by the radar, determine the locations of surrounding aircraft 14. Yet other information about surrounding aircraft 14 can be obtained from other sensors or sources. For example, information about the geo location and altitude of the surrounding aircraft 14 can be obtained from ADS-B broadcasts from the surrounding aircraft, received for example by radios 56 of the aircraft 10.

Image component 87 receives data or information from the cameras such as forward-facing camera 66 and rearward-facing camera 68, and identifies or extracts relevant features or other information elements from images. For example, regions of interest, such as images portions representative of one or more of the aircraft 10, airport 12, surrounding aircraft 14 or airport features 15 may be identified by the image component 86. As another example, regions of interest having color information, such as the colored light from PAPI lights 16, and the specific color states of those lights (e.g., green, red, white, flashing) can be determined by image component 87 from the information representative of the images provided by the cameras 66, 68. Embodiments of the image component 87 may also use other data or information provided by the avionics system 50 or other components of its navigation and display system processing component 53 to identify and extract relevant information elements from the images produced by cameras 66, 68. For example, information representative of locations in the images of structures or regions of interest may be received from the vector component 84 and the location component 86. In embodiments, the image processing component 87 uses image feature extraction model 105 of the storage component 55 to generate the data or information representative of the relevant features or information elements. Image extraction feature model 105 may be a trained model. In embodiments, for example the image feature extraction feature model 105 is trained using aviation-related features and information elements (e.g., images including runways, PAPI lights, ATC towers) to enhance the accuracy and comprehensiveness by which the information elements are identified in the images. Image component 87 and other components 80 of the navigation system and display processing component 53 may use the stored camera information 107 of the storage component 55. Camera information 107 includes information, such as metadata, related to the cameras such as 66, 68 on the aircraft 10. Examples of the camera information 107 include the location and orientation of the cameras on the aircraft, image size, and calibration and distortion data matrices. The camera information 107 can be used by the image component 87 and other components 80 in connection with the processing of the images to provide the functionality described herein in an efficient and accurate manner.

Annotation component 88 receives data or information provided by the other components 80 of the navigation and display system processing component 53 or other components of the avionics system 50, and generates overlays or annotations that are displayed by the display 58. Embodiments of the annotation component 88 generate the annotations using information from the storage component 55, such as from annotation features maps 103 and user customizations 104. As described in greater detail below, annotations generated by the annotation component 88 may include identifiers and/or related descriptive information including locations of structures and/or regions of interest such as for example airports 12, ground feature 15 and surrounding aircraft 14 that are displayed by the display 58 on a live streaming image from a camera 66, 68. Examples of annotations generated by the annotation component 88 also include arrows or pins pointing to structures or regions of interest, descriptive information of the structures or regions of interest (e.g., airport name, aircraft tail no.) and color state remapped portions of streaming images provided by the display 58 in connection with color-based ground features such as PAPI lights 16 and light beacons from ATC towers (e.g., to enhance their intelligibility to colorblind pilots). Yet another example of annotations generated by the annotation component 58 include symbols representative of color-based structures or regions of interest, such as for example symbols indicating light systems such as PAPI lights 16 and/or the color states of the light systems. In embodiments the annotations are located on the streaming image at locations corresponding to the locations of the associated structures or regions of interest in the image (e.g., as determined for example by the vector component 84). Examples of annotations generated by the annotation component 88 also include text corresponding to audio information received by the avionics system 50.

Data structures or other information defining the nature of the annotations generated by annotation component 88 is stored by the annotation feature maps 103 and/or user customizations 104 in embodiments. Annotation feature maps 103 can, for example, include color state maps that define the remapping of first color states in the image to associated different second color states (e.g. to enhance the ability of colorblind pilots to perceive the information being conveyed by the original color state of a color-based ground feature. As another example, annotation feature maps 103 can define the nature, layout, organization or other characteristics of the annotations. Examples of such annotation characteristics include a pin or arrow pointing to the location of the structure or region of interest, a shape outline or filled shape circumscribing a structure or region of interest such as a runway, the types, locations and/or colors of text information such as identifiers of the structure or region of interest (e.g., airport identifier, aircraft tail no. or other identifier, runway number). Yet another example of annotation feature maps 103 includes a symbol map the defines a symbol representative of a structure or region of interest. Symbol map versions of the annotative feature maps can, for example, include symbols associated with each of a plurality of different structures or regions of interest, and in embodiments are also associated with each of a plurality of different colors states of the structures or regions of interest.

Some embodiments of the avionics system 50 enable the pilot or other user to customize one or more features of the annotations generated by the annotation component 88 and the briefing information displays. Examples of such customizable features include the nature, layout, organization and color themes of the annotations and briefing information displays, and the color states of color remaps. The customizations can, for example, be selected by use of the control component 62 of the display 58, and stored by the user customizations 104. In embodiments including user customizations 104, annotation component 88 can generate the annotations and briefing displays based upon the stored user preferences.

Display driver 89 causes images corresponding to the visual information generated by the avionics system 50 to be graphically or visually displayed by the display 58. For example, and as described in greater detail below, the display driver 89 can cause the images from one or more of the cameras, such as the forward-facing camera 66, to be presented as a real-time streaming image corresponding to the FOV seen by the pilot from the aircraft, including while the aircraft is moving. The display driver 89 can also cause the annotations generated by the annotation component 88 to be displayed by the display 58, for example on one or both of the image component 60 or the control component 62. The display driver 89 can also cause data structures defining briefing broadcast information displays to be presented by the display 58.

Clock component 90, which includes or otherwise receives time information from a precision clock (not separately shown), synchronizes actions performed by the navigation and display system processing component 53. For example, images received from cameras such as 66, 68 are time-synchronized (e.g., using timestamps) with information received from other components of the avionics unit 52 such as the sensors 54 (including information from GPS receiver 70) radios 56 and microphone 57 by the clock component 90 in connection with the functionality described herein.

### Navigation Information Annotation Embodiments

Navigation information annotation embodiments include displaying annotations identifying and/or including information relating to one or more features (e.g., structures and/or regions of interest) of airports such as 12 on a displayed streaming image from an aircraft 10 that may include the airport. Alternatively or additionally, the streaming image may be a simulated streaming image of the field of view from the aircraft 10, such as for example when the aircraft is operating at night, under instrument flight rules (IFR) and/or low visibility conditions.

Systems such as those described generally with reference to FIGS. 2-4 can be configured to provide these navigation information annotation embodiments, for example in aircraft 10 operating in environments such as 8 described with reference to FIG. 1. In embodiments, the airport feature identifiers are located on the streaming image at a location corresponding to the location of the associated airport feature on the streaming image (e.g., adjacent or next to, such as above, below, or on the side of the airport feature). By these embodiments, the airport feature and/or other feature identifiers are overlayed onto the live streaming image.

Examples of the types of airport features that can be identified include the location and/or name of the airport, the one or more runways at the airport, the runway number associated with each runway, and light systems at the airport. For example, a line, pin or arrow may point to the airport and/or runway. A rectangular or other shape outline can circumscribe the portion or region of the streaming image including the airport. A shape outline corresponding to the shape of the runway can circumscribe a perimeter of the runway. A line or shape fill area may overlay the runway. In some embodiments, other navigational information such as the heading of the aircraft 10, for example compass headings, speed of the aircraft, horizon, bank or roll angle, pitch and/or altitude of the aircraft may be displayed.

Annotations in the form of navigational overlays on the streaming images can increase a pilot's navigational and situational awareness. The cameras of the avionics systems may also be used for pre-flight and/or during flight troubleshooting (e.g., verifying situations such as gear down, flaps in position, presence of visible icing), thereby providing a comprehensive view of the aircraft and its surroundings.

By these embodiments, the cameras provide a live view of the environment surrounding the aircraft. Annotations such as airport feature identifiers are added to or overlayed onto the streaming image. Avionics system components such as the GPS and IMU provide the aircraft's location and orientation (e.g., ownship data). A database, such as for example NASR, can be accessed based on the aircraft location to identify features such as airports and runways. Based on data or information such as an image feed from a camera, aircraft location and orientation, and locations of the airports and runways can be targeted. Vectors can be calculated between the aircraft's current location and the runway or other feature locations. These vectors can then be transformed from the coordinate system of the location and orientation (e.g., the GPS) coordinate system, to the pixel coordinate system of the camera image. Real-world features or objects can then be accurately overlayed into the image from any one or more of the cameras on the aircraft.

Locations of the airport features that can be the subject of identifiers can be accurately identified from the database information. Data and information available from NASR, for example, includes extensive geocoordinate information on the locations of large numbers of airports and associated runways and other features. In embodiments, the NASR information can be downloaded to and stored by the avionics system of the aircraft, and local copies updated as those updates become available. For example, this geocoordinate information includes information on the locations of the runway corner coordinates, so both ends and sides of the runways can be determined, thereby enabling accurate and detailed feature identifiers that are accurately placed onto the images. Other embodiments may alternatively or additionally use other databases, such as for example the Airport Data and Information Portal (ADIP).

The airport feature identifiers can be added to the streaming image automatically (e.g., if within a predetermined distance of the aircraft), or in response to a pilot request (e.g., a voice request received by a microphone or by actuation of a graphical or other user interface). For example, the pilot may make an audio request by stating “Show me how to get to Duluth International Airport.” In response, a feature identifier such as a pin labeled with the Duluth airport can be generated and presented at the corresponding location of the streaming image. If the location is not within the image FOV, the feature identifier may include an arrow pointing in the direction of the airport, thereby showing the pilot how to get to the airport. As another example, the pilot may make an audio request by stating “Show me the PAPI lighting for Duluth runway 27.” In response, a feature identifier, such as for example a shape outline box or a pin, either of which may include associated text, may be added to the image. The annotated streaming image can be updated in real time as the aircraft changes location and orientation.

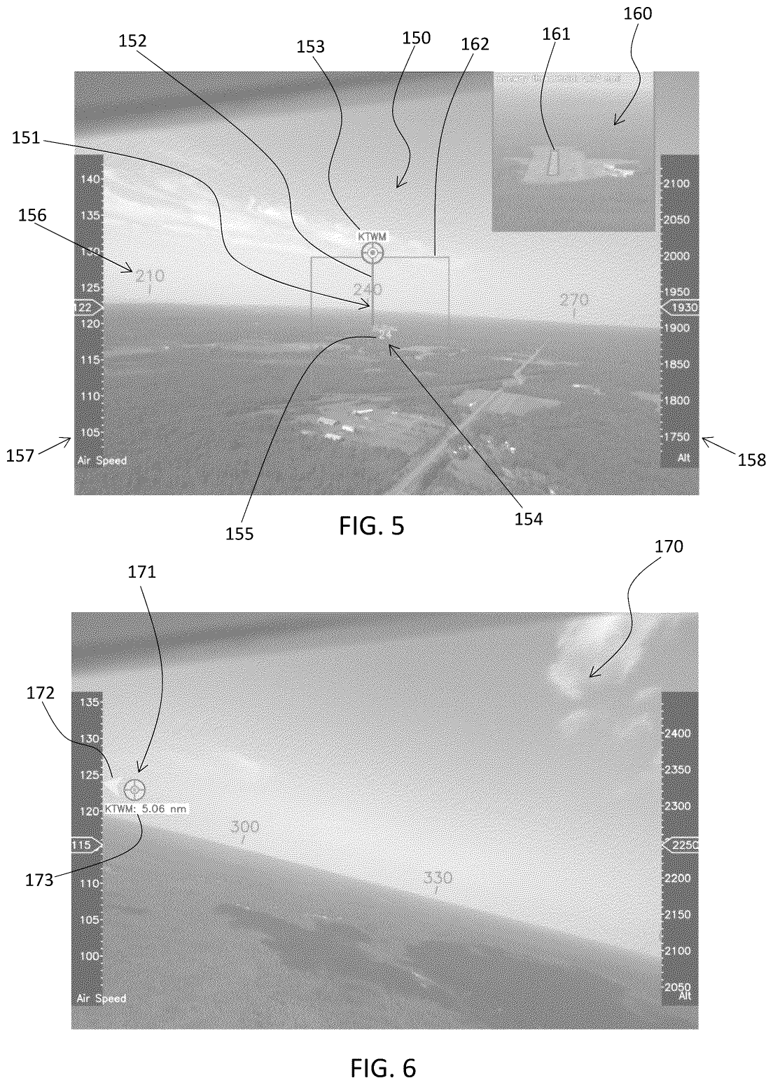

FIG. 5 is an exemplary image 150 (e.g., one still image) of a live streaming image with navigation annotations in accordance with embodiments. Image 150, which is generated from a video signal from a forward-facing camera in an aircraft and includes a FOV the pilot would see out the front of the aircraft from its cockpit, includes an airport feature identifier 151 shown as including a line or pin 152 pointing to the location in the image of the airport identified by the international air transport association (IATA) code “KTWM,” and a text box 153 listing the IATA code. An airport feature identifier 154 shown as a text box 155 listing the runway number (“24”) is located at the location of the leading or base end of the runway in the image 150. In embodiments, where the pilot has requested a feature identifier for a specific runway, overlaying the feature identifier such as 154 listing the runway number at the base end of the runway can indicate which end of the runway to target. Alternatively, the feature identifier can indicate (e.g. be located or annotated by color) that the pilot is targeting the incorrect end of the runway.

Although perhaps not visible in FIG. 5 because of the size of the runway with respect to the scale of the image 150, an airport feature identifier, such as shape outline around the perimeter of the runway, is located on the image to identify the specific location of the runway at the airport.

Also displayed in the image 150 are the headings (“210,” “240,” and “270”) of a compass display 156 corresponding to the direction of travel of the aircraft, airspeed display 157 with the current speed of the aircraft (“122”) displayed and highlighted, and altitude display 158 with the current altitude of the aircraft (“1930”) displayed and highlighted. In some embodiments, feature indicators associated with runways that are not the requested or targeted runway can be added to the image.

In embodiments, aspects of one or more of the feature identifiers may be color-coded to represent information. For example in the image 150, the feature identifier 154 can display the runway number in green color state font to indicate a range of relative alignment of the aircraft with the runway. Other color states can be used for other alignment situations, such as displaying the runway number in yellow font to indicate a range of relatively perpendicular alignment of the aircraft with the runway, or in red font to indicate a range or relatively opposite alignment (e.g., alignment with the opposite end) of the aircraft with the runway.

The embodiments of image 150 shown in FIG. 5 also includes an enlarged or zoomed-in and detailed image 160 (e.g., a picture in picture or PiP) of the airport and/or runway. The detailed image may enable pilots to identify obstructions or obstacles on or around the runway from greater distances. The detailed image 160 can, for example, be generated from the video feed of the camera used to produce the image 150 (if for example that camera is a sufficiently high resolution and wide field of view camera), or a dedicated zoom camera. Detailed image 160 includes a feature identifier 161 shown as a shape outline surrounding the perimeter of the runway. In the illustrated embodiments, image 150 includes a feature identifier, shown as a shape outline 162, around the portion of the image corresponding to the detailed image 160 (e.g., the region if interest including the airport). Additionally or alternatively, other airport features such as runway lighting may be identified, and feature identifiers associated with such airport features can be generated and added to the detailed image 160 in a manner similar to those described above.

In embodiments, the pilot can actuate a user interface to select presentation of the detailed image 160 (e.g., to turn the inclusion of the image on and off), the size of the detailed image (including both its presentation size and the size or area of the image 150 included (e.g., the amount of zoom) and the location of the image on the display. In embodiments, for example, image 150 and detailed image 160 are presented on a touch-screen display, and these pilot-selectable features can be controlled by finger-touch actuation of the display. In these and other embodiments the pilot can also switch between display of the image 150 and the detailed image 160 by actuation of the user interface (e.g., by double tapping on a touch-screen display). Some embodiments may be configured to autonomously determine which image (e.g., image 150 or image 160) to display, with the user interface configured to allow the pilot to override or switch the autonomous selection. Image 150 and/or detailed image 160, and the corresponding feature identifiers, are continually updated (e.g., they will change in real time in correspondence to the location and orientation of the aircraft with respect to the airport).

FIG. 6 is an exemplary image 170 of a live streaming image with navigation annotations in accordance with embodiments. The airport identified by the code KTWM is not in the FOV of the image (e.g., the aircraft is not heading directly toward the airport). However, an airport feature identifier 171 is shown as including an arrow 172 pointing in the direction of the airport, and a text box 173 listing the IATA code and distance of the airport from the aircraft. The feature identifier 171 is shown in the left side of the image 170 corresponding to the direction of the airport to the left of the aircraft. As is also evident from image 170, because of the downwardly and to the right slope of the horizon, the image is taken while the aircraft is banking to the right, away from the airport identified by the feature identifier 171.

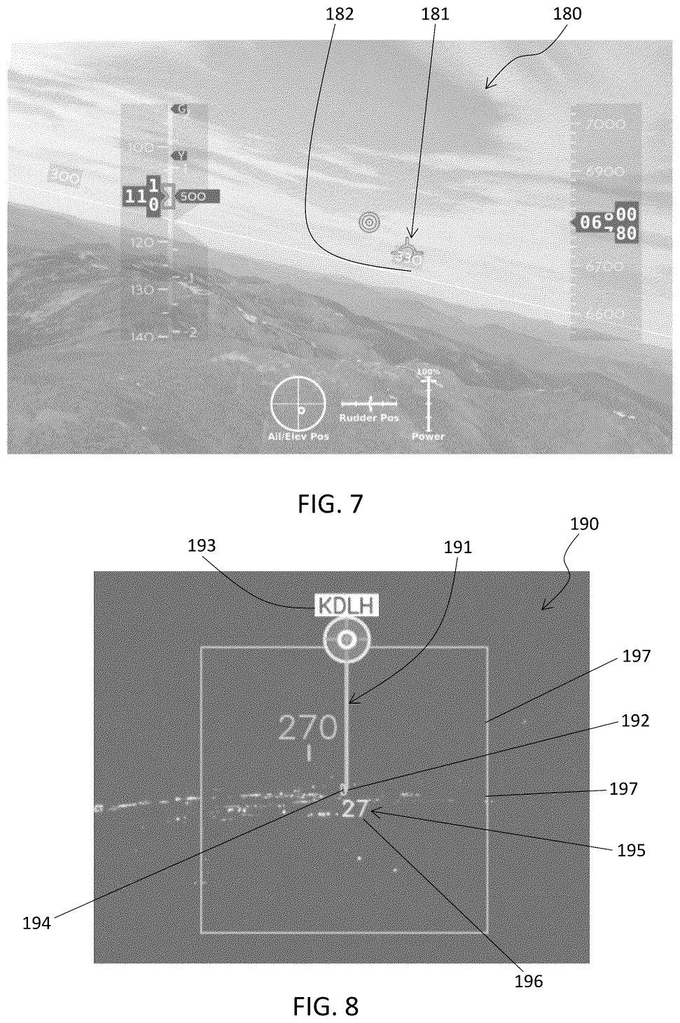

FIG. 7 is an exemplary image 180 of a live streaming image with navigation annotations in accordance with embodiments. The airport is beyond the horizon of the FOV of the image 180. An airport feature identifier 181 shown as an arrow 182 points to the location of the airport beyond the horizon in the image 180.

FIG. 8 is an exemplary image 190 of a live streaming image with navigation annotations in accordance with embodiments. The image 190 is during a nighttime flight, and the airport identified by the code KDLH is in the FOV of the aircraft. The image 190 is annotated with a feature identifier 191 shown as including a pin 192 pointing to the location of the airport, a text box 193 listing the IATA code, and a shape outline 194 around the perimeter of the runway.

Image 190 is also annotated with a feature identifier 195 shown as a text box 196 listing the runway number (“27”) located at the leading or base end of the runway. In this embodiment the runway number of the feature identifier 195 may displayed in green font to indicate that the aircraft is aligned with the targeted or desired end of the runway (e.g., requested by the pilot). If, for example, the aircraft was aligned to land on the opposite end of the runway (e.g., runway “9”) from the desired end requested by the pilot, the feature identifier may be displayed in a different color state font, such as red. A feature identifier 197 in the form of a shape outline identifies a region or portion of the image 190 including the airport that can be displayed as a detailed image (not shown). Feature identifiers of these types can help pilots determine that they are aligned to land on the desired or correct runway.

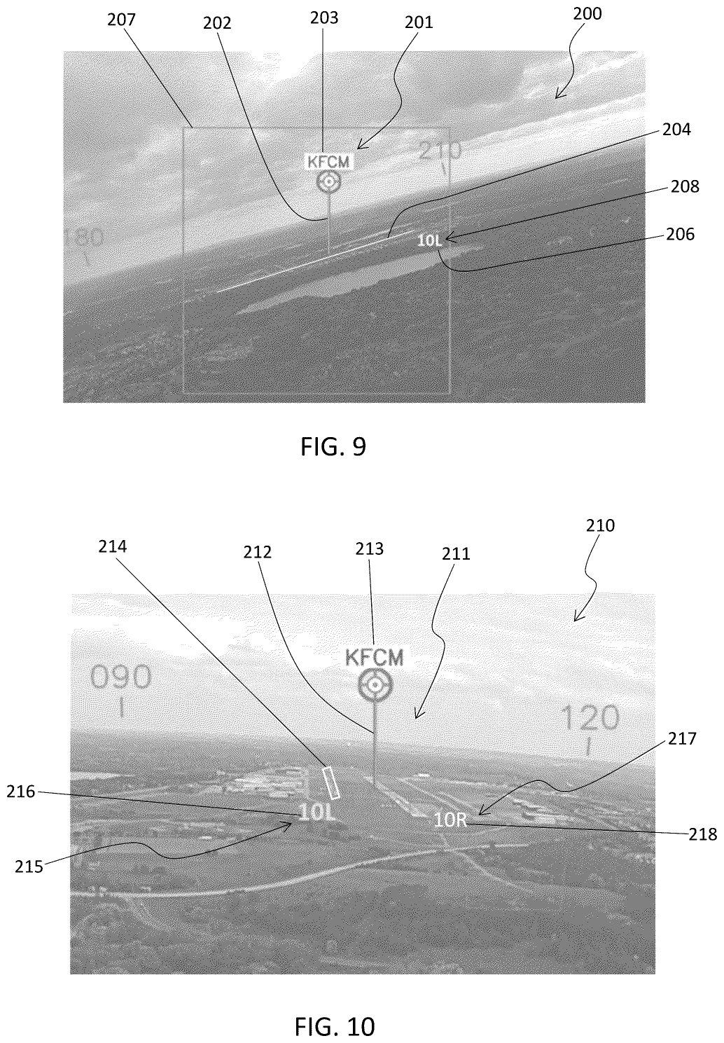

FIG. 9 is an exemplary image 200 of a live streaming image with navigation annotations in accordance with embodiments. Image 200 is annotated with a feature identifier 201 shown as including a pin 202 pointing to the location of the airport, a text box 203 listing the IATA code for the airport (“KFCM”), and a line 204 on and along the length of the runway. Image 200 is also annotated with a feature identifier 205 shown as a text box 206 listing the runway number (“10L”), which may have been requested by the pilot. In embodiments, the feature identifier 205 may be displayed in yellow font to indicate that the aircraft is not aligned with the requested runway. A feature identifier 207 in the form of a box-shaped outline identifies a region or portion of the image 200 that includes the airport and runway, and that can be displayed as a detailed image (not shown).

FIG. 10 is an exemplary image 210 of a live streaming image with navigation annotations in accordance with embodiments. The image 210 is annotated with a feature identifier 211 shown as including an arrow 212 pointing to the location of the airport, a text box 213 listing the IATA code for the airport (“KFCM”), and an outline box 214 around the perimeter of the runway (“10L”). Image 210 is also annotated with a feature identifier 215 shown as a text box 216 listing the target runway number (“10L”) located at the leading or base end of the runway. In this embodiment the runway number of the feature identifier 215 may be displayed in green font to indicate that the aircraft is aligned with the targeted or desired end of the runway requested by the pilot. The airport shown in the image 210 also has a second runway, and the image is annotated with a feature identifier 217 shown as a text box 218 listing the runway number (“10R”). In embodiments, because the runway 10R is not the target runway, the feature identifier 217 may be displayed in a font color, such as red, to indicate that it is not the target runway.

Navigation annotations of the types described above can be displayed using any of a plurality of different identifier element themes. Examples of identifier element aspects that can be different for different themes include colors of the feature identifiers, levels of detail of the feature identifiers, font sizes and camera views. Navigation and display systems in accordance with embodiments may have one or more predetermined themes that a pilot can select from.

Additionally or alternatively, the navigation and display system can be configured to allow the pilot to create and store one or more customized themes. The themes can be saved to separate profiles, for example for different pilots of the aircraft.

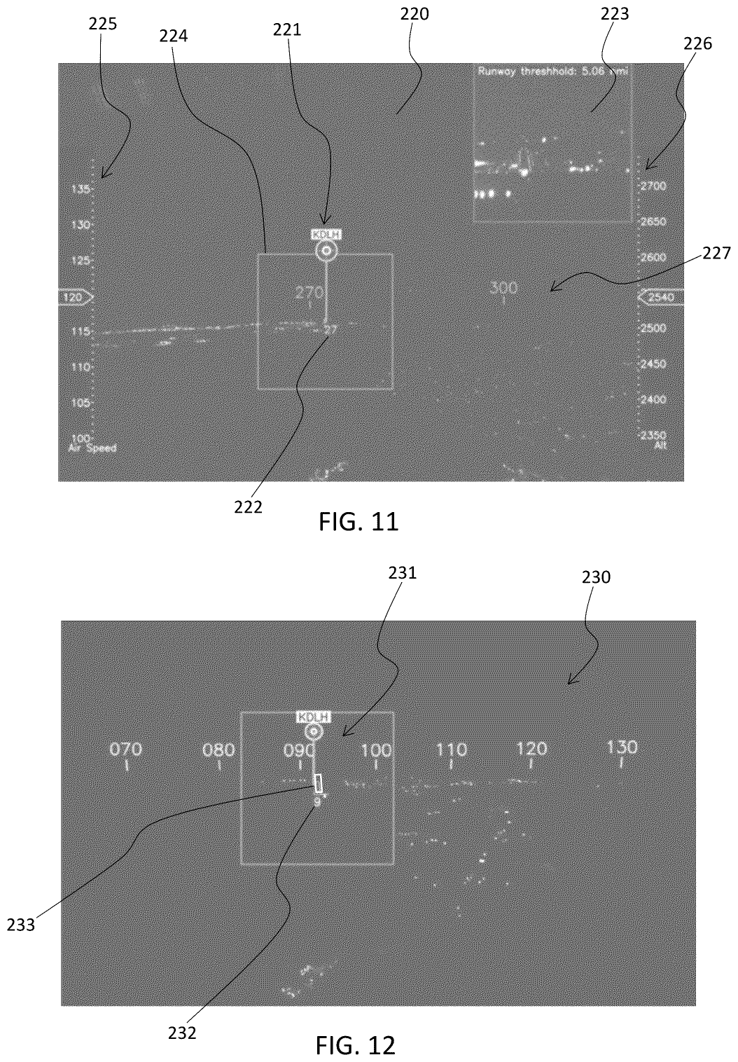

FIGS. 11-14 are exemplary illustrations of images 220, 230, 240 and 250, respectively, of live streaming images with navigation annotations in accordance with embodiments having different themes. The image 220 of FIG. 11 is from an aircraft during a nighttime flight, and is shown in a first theme, with all feature identifiers on with colors in night mode to enhance their visibility. The illustrated embodiment includes an airport feature identifier 221, and a runway number feature identifier 222. Image 220 also includes a detailed image 223, and a rectangle shape outline 224 in the image 220 showing the location of the detailed image. An air speed display 225, altitude display 226 and compass display 227 are also added to the image 220.

The image 230 of FIG. 12 is from an aircraft during a nighttime flight, and is shown in a theme that is different than that shown in FIG. 11. The theme of the image 220 includes an airport feature identifier 231, a runway number (“9”) feature identifier 232, and a runway perimeter feature identifier 233 in the form of a shape outline. Unlike the theme of the image 220 (FIG. 11), the theme of image 230 does not include a detailed image or airspeed and altitude displays. Colors of the feature identifiers in image 230 may be different than colors of the feature identifiers in image 220.

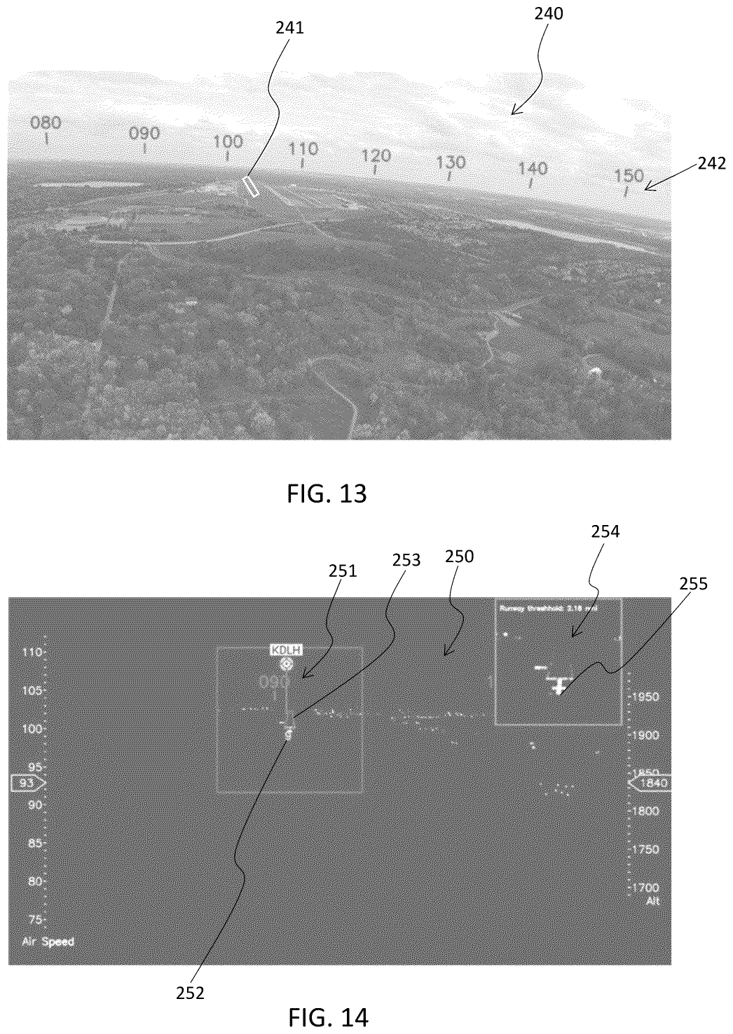

The image 240 of FIG. 13 is defined by a theme that includes a runway perimeter feature identifier 241 in the form or a shape outline and a compass display 242. Other feature identifiers, such as an airport feature identifier and a runway number feature identifier are not added to the image 230.

The image 250 of FIG. 14 is from an aircraft during a nighttime flight, and is shown in a theme having colors in a night mode. Feature identifiers added to image 250 include an airport feature identifier 251, a runway number (“9”) feature identifier 252, and a runway perimeter feature identifier 253 in the form of a shape outline. Image 250 also includes a detailed image 254 that has a runway identifier feature 255. Airport feature identifiers of the types described above may also be presented on displays when the aircraft is flying under instrument flight rule (IFR) conditions (e.g., when the airport features of interest may not be visible in the FOV of the display because of cloud cover).

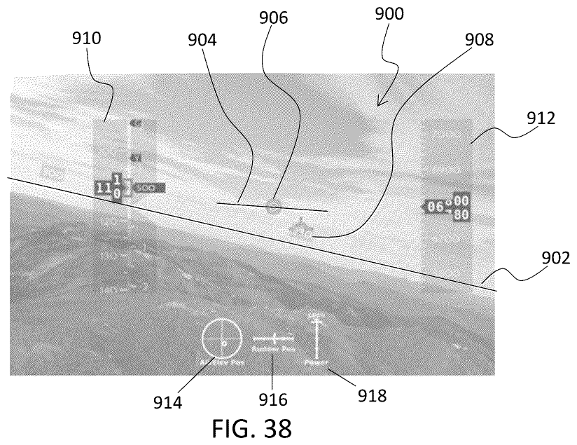

FIG. 38 is an exemplary image 900 (e.g., one still image) of a simulated live streaming image with navigation annotations in accordance with embodiments. Image 900, which can, for example, be provided when the aircraft 10 is operating under instrument flight rules (IFR) or in cloudy or other low-visibility conditions, includes a full or partial simulated image corresponding to the FOV that would be presented by the cameras. The simulated image 900 is updated as the aircraft 10 changes positions and locations. In embodiments, the image 900 is a full simulated image. In other embodiments, the image 900 can include simulated portions overlaid onto actual images provided by cameras such as 66, 68 (e.g. an augmented reality image. In embodiments, the simulated image of the FOV such as that shown at 900 can be provided by a database of terrain images, and modified based on information such as the altitude, direction and orientation of the aircraft so as to correspond to a view that would be presented if the view from the aircraft was not obscured. Annotations added to the image 900 in the illustrated embodiments include a line 902 representing the actual horizon in the FOV, a line 904 representing the bank or roll angle of the aircraft with respect to horizonal, an indicator 906 representing the pitch of the aircraft, a compass heading display, including an indicator 908 showing the current heading of the aircraft, a speed indicator 910 and an altitude indicator 912. The illustrated embodiments also include annotations 914, 916 and 918 indicating the aileron/elevator position, rudder position and engine power level, respectively.

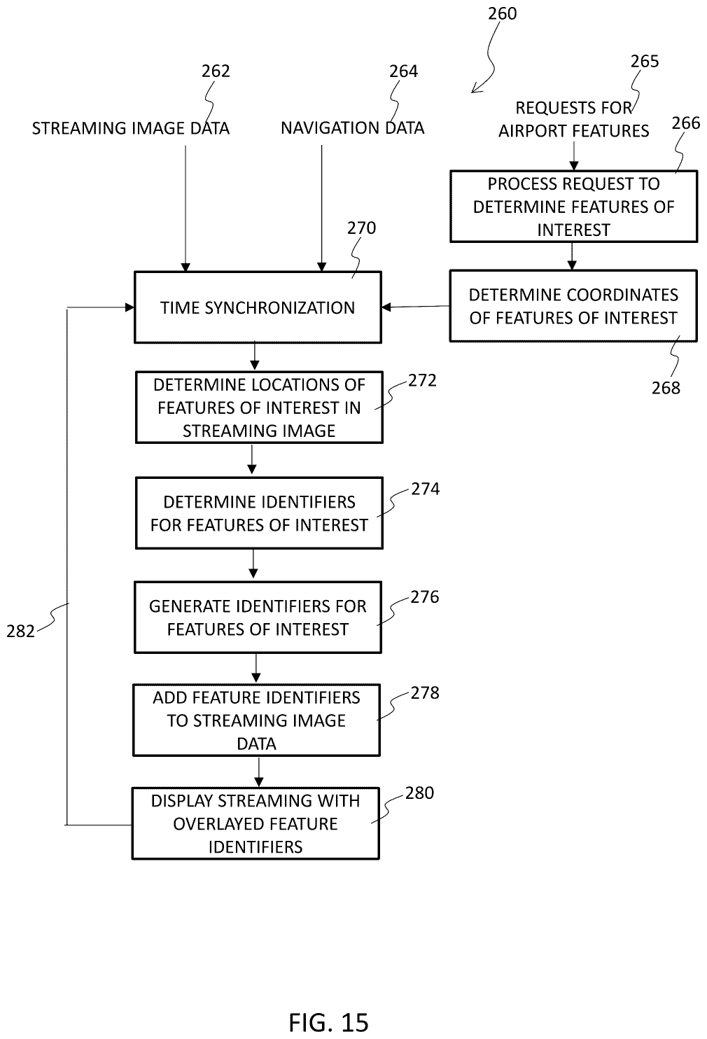

FIG. 15 is a diagrammatic illustration of a method 260 for generating an aircraft display including streaming images with navigation annotations in accordance with embodiments. All or some of the steps of the method 260 can, for example, be performed by the avionics system 50 described in connection with FIG. 3 and its navigation and display system processing component 53 and storage component 55 described in connection with FIG. 4. Alternatively or additionally, all or some of the steps of method 260 can be performed off the aircraft, for example by the computing system 36 and/or navigation information sources 38 (e.g., in the cloud), and the associated data and information communicated to and from the aircraft 10 via the communication system 30. The following description of the method 260 includes exemplary references to the avionics system 50 and its components 53 and 55, and to the communication system 30, computing system 36 and navigation information sources 38.

As shown in FIG. 15, method 260 receives as inputs one or more streaming images, each of a FOV from the aircraft 10 (step 262), and navigation information of the aircraft (step 264). The streaming images may, for example, be received from one or more of the video cameras on the aircraft, such as the forward-facing camera 66 or the rearward-facing camera 68. The navigation information may, for example, be received from one or more of the GPS receiver 70 or the IMU 72.

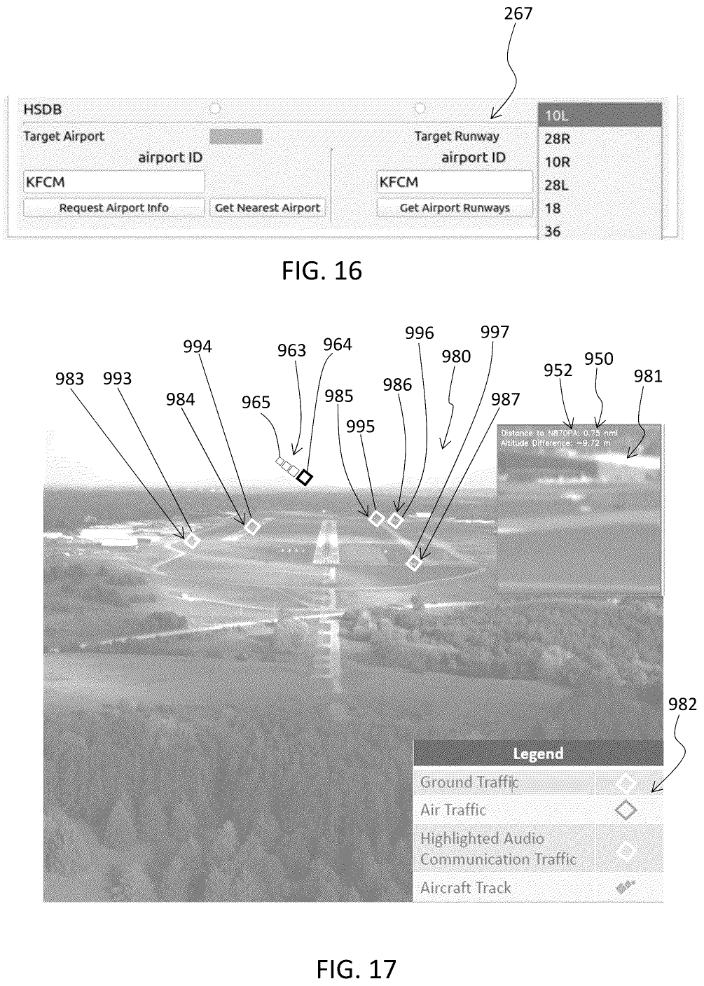

An airport feature request may also be received (step 265) in connection with the method 260. For example, the airport feature request may include one or more of (1) a request for a particular airport, optionally by airport name, city or other location, or IATA code, or (2) a particular feature at the airport, such as for example a particular runway at the airport, or set of lights, such as for example PAPI lights, at the airport. In embodiments, the airport feature request is an audible or verbal request, for example received by the microphone 57 when the pilot speaks. Additionally or alternatively, as another example the airport feature request may be received by user actuation of a user interface such as that provided by the control component 62 of display 58 (e.g., by touch or gesture). FIG. 16 illustrates an exemplary user interface display 267 that can be used by a pilot in connection with the airport feature request step 265. As shown, the interface display 267 includes user-actuatable objects (e.g. by voice or touch) to select both a target airport and a target runway at the target airport. In connection with the airport feature request of step 265, the feature information may be retrieved from a locally-saved copy on the aircraft (e.g., from the navigation information sources 106) or from other sources such as the navigation information sources 38 off the aircraft (e.g., via the communication system 30 and the cloud).

In yet other embodiments, airport feature requests by step 265 may effectively be performed automatically. For example, a pilot may have stored information that causes certain airport features, such as for example the locations and associated identifiers of airports within certain distances of the aircraft and/or in directions toward which the aircraft is heading, received by step 265. The automatic receipt of airport features by this approach may, for example, be configured by a pilot-selected theme or other user customization stored, for example in the user customizations 104 of the storage component 55.

At step 266, method 260 processes the airport feature requests of step 265, if necessary or otherwise appropriate, to identify the features of interest in in the requests. For example, if the requests at step 265 are audible requests, the navigation and display system processing component 53 may perform natural language processing (NLP) on the audible requests to identify the features of interest (e.g., airport, runway, light system) from the other audible portions of the request. In embodiments, the NLP can include a multistep approach by first converting the audible request to text form, for example by the speech recognition processing component 83, and then parsing the text form of the request, for example by the information extraction processing component 85, to identify the airport features of interest. In other embodiments, such as for example when the requests are made via a touch-actuated user interface that identifies the particular airport feature of interest (e.g., a touch-screen version of the user interface display 267 shown in FIG. 16), the processing of step 266 may not be needed.

At step 268, method 260 determines the locations of the requested airport features. In embodiments, the geo coordinates of the requested airport features are determined at step 268. For example, the locations of the airport features can be determined from NASR information stored by the navigation information sources 106 of avionics unit 52, or accessed from sources off the aircraft such as navigation information sources 38.

At step 270, one or more of the streaming image information (from step 262), the navigation information (from step 264) and the locations of the requested airport features (from step 268) are time synchronized, as needed or appropriate. For example, the streaming image information and the navigation information may include time stamp information representative of the times that the information is captured or received. Accuracy of the positional locations of the airport feature identifiers on the displayed streaming image can be enhanced by sufficiently time-synchronizing the information at step 270. Time synchronization of the features of interest may, for example, include determining if the requests are for new airport feature identifiers to be added to the streaming image, or updates to existing overlayed feature identifiers.

At step 272, method 270 determines the locations of the features of interest in the streaming image. By this step 272, the method can determine the locations on the streaming image at which the associated airport feature identifiers are to be displayed. For example, the locations of airports and/or runways to be pointed to by feature identifiers in the form of lines or pins, the locations of leading or tailing ends of runways to be identified by feature identifiers in the form of runway numbers, the perimeters of runways to be identified by feature identifiers in the form of a box or other shape outlining the perimeter of the runway, and/or the location of airport lights, can be identified. In embodiments, vector processing, such as that performed for example by the vector component 84, can be performed by method 260 based upon the streaming image information (step 262) and the navigation information (step 264) to determine the locations of the features of interest in the streaming images.

At step 274, method 260 determines the type of feature identifier associated with the feature of interest. Information defining the type of feature identifier determined at step 274 may, for example, be determined by accessing the annotation feature maps 103 of the storage component 55 based upon the type and/or characteristics of the feature of interest. As discussed above, the stored annotation feature maps 103 may, for example, include templates or other data structures associated with the different types of airport features. Examples of such templates include the “target” symbol and associated pin and airport identifier features and layout of an airport feature identifier such as 151 shown in FIG. 5 and the “target” symbol and associated arrow and airport identifier features and layout of the airport feature identifier 171 shown in FIG. 6.

At step 276, method 260 generates the airport feature identifier. In embodiments, at step 276 the airport feature identifier can be generated based upon the information associated with the feature of interest and the template or other identifier information determined by step 274. For example, the airport feature identifiers 151 and 171 shown in FIGS. 5 and 6, respectively, can be generated by incorporating the airport IATA code into the airport feature identifier template or data structure. As another example, the runway perimeter shape outline 214 shown in FIG. 10 can be generated. The airport feature identifier generated at step 276 may, for example be based upon the information of the nature of the identifier determined at step 274 and the information defining the runway perimeter in the streaming image determined at step 274.

At step 278, the airport feature identifier generated by step 276 is added to the streaming image data at the appropriate location determined by step 272 (e.g., the streaming image is annotated with the features identifier). The video information defining the streaming image annotated with the airport feature identifier is then displayed, for example by the image component 60 of the display 58, as shown by step 280.

Steps of the method 260 that are needed or otherwise appropriate to cause the requested airport feature to be displayed (e.g., continuously or periodically) as the streaming image is displayed in real time may be repeated. For example, if the aircraft 10 is in flight, the FOV of the streaming image will continuously change with the motion of the aircraft. Steps of the method 260 needed to continue to add the airport feature identifier to the streaming image at the appropriate location in the streaming image are repeated, as indicated generally by step 282. In embodiments, one or more portions of the method 260 may not be needed to maintain the display of the airport feature identifier on the streaming image by step 282. For example, after the nature of the identifier is determined for the feature of interest at step 274 and the associated feature of interest is generated at step 276, the feature of interest generated by those steps may be resized and effectively reused as appropriate for changes to the scale of the FOV and added to the streaming image at step 278 without the need to reperform those steps.

Avionic systems and methods that provide navigational overlays in accordance of these types can provide important advantages. For example, they may lower barriers to enter aviation. They may simplify complex situations by providing relatively easy to follow visual indicators such as those that provide directional guidance to an airport and runway. A pilot's navigational awareness can be increased by runway/airport navigation pins, compass in the sky above the horizon, and runway number, optionally color coded to indicate alignment. Pilot situational awareness can be increased, for example by the zoomed runway regions to show obstructions/other aircraft, airspace classes, known icing conditions or weather conditions. A pilot's navigational/situational awareness in instrument flight rules (IFR)/night conditions can be aided. For example, it may be easier to find an airport/runway from further away or greater distances with arrows and pins, and zoomed runway region displays with greater clarity. Aviation support for pilots and other users with disabilities is increased. For example, elements can be resized, zoomed regions may show greater details, and colors can be changed. Future automated systems may be supported. For example, additional troubleshooting/monitoring may be provided through surround camera views. Areas of troubleshooting/monitoring such as gears/flaps position, icing on wings and underside leaks.

The overlays and annotations in the form of airport feature identifiers may be defined within the context of aiding pilot navigation. Airport information, such as the FAA's airport/runway information database can be converted to a form usable with the system and method and allow the overlays to be drawn at any airport or runway, for example as requested by the pilot. A range of different types of visual elements may be brought together for general aviation. The system and display can be highly customized, for example by users defining their own themes or using preset themes to define aspects such as colors, /sizes/layout or other elements on the display. Placing the airport feature identifier overlays on the live camera feed provides real-world reference to elements drawn on the display (e.g., as opposed to synthetic displays), thereby better facilitating a pilot's ability to cross-reference the display and real world. Multiple cameras and zoomed picture-in-picture views enhance the display.

One example of the navigation annotation embodiments is a method, for example performed by one or more processors. Steps of the method may comprise: receiving, from a camera on the aircraft, a streaming image from the aircraft; receiving navigation information representative of a location and orientation of the aircraft; receiving airport feature information associated with each of one or more airport features; determining, based upon the navigation information and the airport feature information, a location of each of the one or more airport features with respect to the streaming image; generating an airport feature identifier for each of the one or more airport features; generating an airport feature-annotated streaming image based upon the streaming image and including each airport feature identifier, wherein each airport feature identifier is at a location in the feature-annotated streaming image corresponding to a location of the associated airport feature; and displaying the airport feature-annotated streaming image in the aircraft.

In some embodiments, determining the location of the one or more airport features includes determining at least one of the one or more airport features is within a field of view of the streaming image; and generating the airport feature-annotated streaming image includes generating the airport feature-annotated streaming image including the airport feature identifier for each of the at least one or more airport features within the field of view at the location of the associated airport feature in the airport feature-annotated streaming image.

In any or all of the above embodiments, determining the location of the one or more airport features may include determining at least one of the one or more airport features is outside a field of view of the streaming image; and generating the airport feature-annotated streaming image includes generating the airport feature-annotated streaming image including the airport feature identifier for each of the at least one or more airport features outside of the field of view at a location in the airport feature-annotated streaming image, optionally a side of the airport feature-annotated streaming image. In embodiments, for example, generating the airport feature identifier for each of the one or more airport features outside the field of view of the streaming image includes generating an airport feature identifier including a pointer to the location of the associated airport feature. For example, the airport feature may include an airport; and the airport feature identifier may include information representative of the airport name.

In any or all of the above embodiments, the airport feature includes a runway; and the airport feature identifier includes one or more of (1) a region of interest identifier, optionally a shape outline circumscribing a region of interest including the runway, (2) a runway shape identifier, optionally a shape outline circumscribing the runway or a fill shape within the runway, (3) a runway number, optionally located at a base of the runway, and optionally color coded based on a direction of approach of the aircraft to the runway, and/or (4) a location pin, optionally including information representative of the airport name.

In any or all of the above embodiments, the airport feature includes a light system; and the airport feature identifier includes one or more of (1) a region of interest identifier, optionally a shape outline circumscribing a region of interest including the light system, and/or (2) a location pin.

In any or all of the above embodiments, the method further comprises receiving a request identifying the one or more airport features; and the step of receiving the airport feature information is responsive to the request identifying the one or more airport features. In embodiments, for example, receiving the request identifying the one or more airport features includes receiving one or more of an audio request or a request via user actuation of a user interface.

In any or all of the above embodiments, the method further comprises receiving information representative of a display theme defining one or more airport feature identifiers; and generating the airport feature identifier includes generating the airport feature identifier based upon the display theme.

In any or all of the above embodiments, the method further comprises generating, based upon the streaming image, a zoomed-in streaming image of a portion of the streaming image including one or more of the airport features; generating an airport feature-annotated zoomed-in streaming image including each airport feature identifier within a field of view of the zoomed-in streaming image at a location in the airport feature-annotated zoomed-in streaming image corresponding to a location of the associated airport feature; and displaying the airport feature-annotated zoomed-in streaming image. In embodiments, for example, displaying the airport feature-annotated zoomed-in streaming image includes displaying the airport feature-annotated zoomed-in streaming image as a picture in picture in the displayed airport feature-annotated streaming image.

In any or all of the above embodiments, receiving the navigation information includes receiving the navigation data from one or both of a GPS receiver or an IMU on the aircraft.

In any or all of the above embodiments, receiving the airport feature information includes receiving the airport feature information from a database of descriptive details of airport infrastructure, optionally via the Federal Aviation Administration (FAA) National Airspace System Resource (NASR) and/or the FAA Airport Data Information Portal (ADIP).

In any or all of the above embodiments, receiving the streaming image includes receiving a streaming image of a field of view in front of a cockpit of the aircraft. In embodiments, for example, displaying the airport feature-annotated streaming image includes displaying the airport feature-annotated streaming image on a visual display in a cockpit of the aircraft.

Another example of the navigation information annotation embodiments comprises a computer system including one or more processors, and memory storing instructions that when executed by the one or more processors causes the one or more processors to perform the steps of any of the embodiments of the method described above.

Yet another example of the navigation information annotation embodiments comprises a non-transitory computer-readable medium storing instructions that, when executed by one or more processors of a computer system, causes the computer system to perform the steps of any of the embodiments of the method described above.

### Surrounding Aircraft Information Annotation Embodiments

Surrounding aircraft information annotation embodiments include displaying annotations identifying one or more features associated with surrounding aircraft such as 14 (FIG. 1) on a displayed live streaming image from an aircraft 10. Systems such as those described generally with reference to FIGS. 2-4 can be configured to provide these surrounding aircraft information annotation embodiments, for example in aircraft 10 operating in environments such as 8 described with reference to FIG. 1. In embodiments, the surrounding aircraft feature identifiers are located on the streaming image at locations corresponding to the location of the associated surrounding aircraft on the streaming image (e.g., adjacent or next to, such as above, below, or on the side of the surrounding aircraft). By these embodiments, the surrounding aircraft identifiers are overlayed onto the live streaming image.

Examples of the type of surrounding aircraft identifiers include identifiers of surrounding aircraft such as 14B-14C that are in flight, aircraft such as 14A that are on the ground, surrounding aircraft that are communicating with the aircraft 10, and/or surrounding aircraft that are communicating, for example via audio comms, with ground-based resources such as air traffic control (ATC) towers at controlled airports or uncontrolled communications (UNICOM) with towerless or uncontrolled airports or other surrounding aircraft. The surrounding aircraft identifiers may also include information relating to other characteristics of the surrounding aircraft, such as for example the track or direction of the surrounding aircraft, its velocity, an identifier such as its call sign or tail number, its on-ground nature, and/or its in-flight nature. The surrounding aircraft identifiers may also include symbols or other elements such as text boxes including the information, color coded information, pins or arrows pointing to the surrounding aircraft (e.g., if outside the field of view), and/or other features or elements such as shape outlines circumscribing all or part of the surrounding aircraft.

The surrounding aircraft identifiers may be generated based on data or information associated with the surrounding aircraft. Embodiments use the Automatic Dependent Surveillance-Broadcast (ADS-B) data transmitted from the surrounding aircraft. The surrounding aircraft identifiers can help a pilot quickly and accurately localize traffic. By the surrounding aircraft annotation embodiments, traffic can be displayed on a live camera feed of the outside world. This approach is applicable in cases where the traffic is at a location where the pilot can move his or her head and see it (e.g., directly in front or to their side—within pilot's field of view (FOV)) with the help of the forward-facing cameras, or where the traffic is at a location where the pilot cannot visually see the traffic (e.g., directly behind his or her aircraft or underneath—outside pilots FOV) with the help of other rearward-facing or other surround view cameras on the aircraft. In embodiments, the surrounding aircraft identifiers may be highlighted to indicate which traffic is being talked about on comms (for example either ATC comms near towered airports, other pilots communicating near untowered airports, or aircraft-to-aircraft comms), and indicating the highlighted traffic's intention from this audio data. These features may help the pilot easily identify traffic, and may therefore increase general aviation safety.

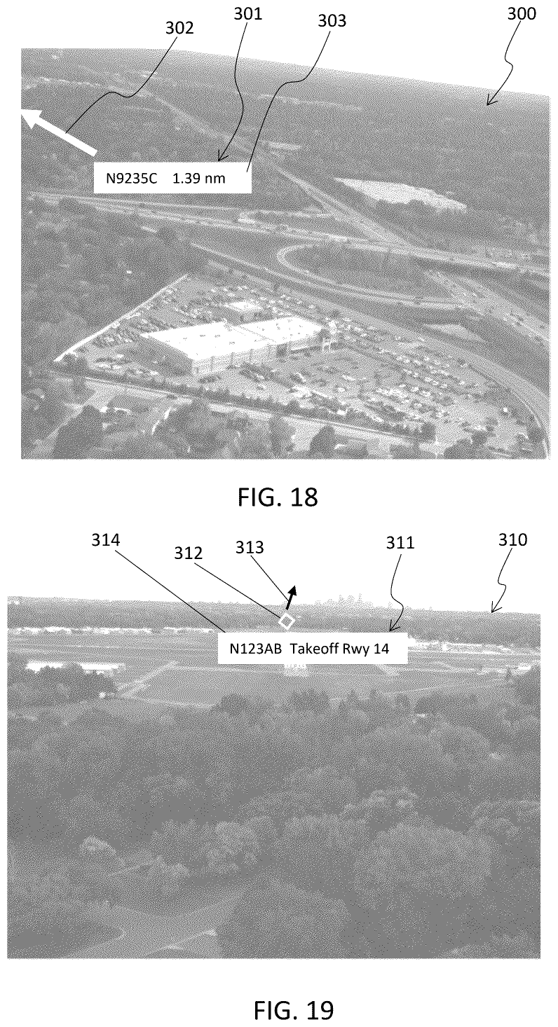

In embodiments, such as for example those described below in connection with FIG. 18, the display and surrounding aircraft identifiers show traffic in the pilot's FOV and indicate where to look when traffic is outside the FOV. The surrounding aircraft identifiers can be highlighted and/or color coded to identify characteristics of associated surrounding aircraft. When displayed on streaming live camera images, the surrounding aircraft identifiers can show where in real space the pilot should look to find the aircraft outside of the front facing FOV. In embodiments, the surrounding aircraft identifiers can include the callsign or tail number of the aircraft, display a zoomed in PiP (picture in picture) view of certain aircraft, altitude and/or aircraft direction of travel or track. The display may be customizable for pilot display preferences. As examples, features can be added to or removed from the display depending on what is helpful to each specific pilot for locating traffic. Aircraft on the ground may be displayed in a separate color.

An important aspect of the surrounding aircraft annotation embodiments is the aid provided to pilots in live localization of traffic when the traffic is outside the FOV. The display may indicate where outside of the front FOV the pilot should look to locate the traffic out of sight. In embodiments, cameras may be placed 180 degrees from the front (e.g., a rearward, out the tail view), and/or other areas where the pilot cannot easily see, to show where in a live camera feed to look for nearby traffic. This feature may be helpful around areas of the aircraft where the aircraft body is obstructing the pilot's view (e.g., under the belly of the fuselage, out the tail, etc.). This feature may also help the pilot quickly locate the surrounding aircraft by using the live camera reference points, even if the traffic is not in the forward FOV.

Embodiments may also include a feature that draws attention to specific surrounding aircraft that are transmitting on a comms channel. For example, surrounding aircraft identifiers associated with surrounding aircraft that are communicating by a comms channel may be color coded or otherwise highlighted (e.g., green) to distinguish those surrounding aircraft from others that are not communicating by comms. When listening on comms as a pilot, it may be difficult to identify outside of the cockpit which traffic is being talked about. In addition to highlighting traffic from audio communications on the display, the surrounding aircraft annotation embodiments can also highlight surrounding aircraft based on a voice request from the pilot that includes, for example, one or more of callsign, relative direction, or a known location. For example, a pilot can request “Highlight traffic N123AB” or “Show all traffic at 3 o'clock” or “Highlight all traffic on final.” Surrounding aircraft navigation embodiments of these types can help with quickly identifying traffic that is being talked about or highlighting traffic that may be otherwise difficult to locate. These embodiments may help pilots identify traffic in the airspace that are being spoken about on comms or specific traffic that the pilot is requesting to identify.

Embodiments may also include displaying and optionally highlighting traffic intention of the surrounding aircraft on the streaming image. For example, in connection with traffic being cleared for take-off from ATC, the display can indicate this traffic's intention is to take-off as part of the surrounding aircraft identifier. As another example, in connection with traffic cleared for landing, the display indicates the aircraft's intention to land as part of the surrounding aircraft identifier. By another example, in connection with ATC giving a cleared for takeoff to an aircraft: “N123AB you are cleared for take-off on runway one two left,” if the aircraft with the surrounding aircraft annotation is on final on runway 12R, the display can show N123AB being highlighted on runway 12L, its intended direction of travel vector, and text which shows its intention to take off on this runway. In addition to traffic direction indications of these types, other indications such as velocity and/or a velocity trail showing the surrounding aircraft's intended speed and direction can be included in the surrounding aircraft identifiers. Surrounding aircraft identifiers of these types can help pilots understand that it is safe to land with the intention of other surrounding traffic. Pilots can more quickly and accurately identify surrounding aircraft traffic.

In embodiments, the avionics system may consider a predetermined number N of aircraft such as 14 in the vicinity of the aircraft 10, for example to optimize the algorithm and associated computing resources. Alternatively or additionally, the avionics system may also calculate a sphere of a radius R surrounding the aircraft 10 that includes all N surrounding aircraft (e.g., ≤N within R). This sphere can then be used to notify a pilot of surrounding aircraft in the immediate vicinity that may pose a collision risk. In other embodiments, the avionics system may generate and display surrounding aircraft identifiers for all aircraft within a predetermined radius, or a predetermined number of the closest aircraft. Knowing aircraft intention, location, and velocity information, it may be possible to better inform the pilot of potential incursions. In yet other embodiments, the avionics system may be configured to display traffic still on the ground (e.g., since ADS-B does not transmit altitude of traffic when it is on the ground). In embodiments of these types, the avionics system may implement or access a database of altitude given latitude and longitude information (e.g., the altitude of the associated airport).

Embodiments of the avionics system and method may also be configured to use other sensors and/or types of data or information (e.g., other than ADS-B information) in connection with the generation and display of surrounding aircraft identifiers. For example, if radar is installed on the aircraft 10, it can be used to identify surrounding aircraft and their location, and or to confirm ADS-B sensor readings of specific traffic in the vicinity. As yet another example, functions of these types can also be provided using vision algorithms with cameras. In embodiments where traffic is confirmed by other sensors, the associated surrounding aircraft identifiers can be displayed using different symbology to differentiate by sensor source. Embodiments may also display surrounding aircraft traffic directions and velocity. The surrounding aircraft identifiers may include symbols or other identifying information showing where the aircraft has recently been, such as for example a velocity trail. Surrounding aircraft displays of these types may effectively illustrate the surrounding aircraft intent.

FIG. 17 is an exemplary image 980 of a live streaming image with surrounding aircraft identifier overlays or annotations in accordance with embodiments. The image 980 illustrates the FOV (field of view) that a pilot of an aircraft such as 10 would see in front of the aircraft while approaching a runway at an airport, and includes a zoomed-in or detailed image 981 of a portion of the image 980 presented as a picture in picture (PiP), and a legend 982 describing the nature or characteristics of certain types of information represented by the surrounding aircraft identifiers. Although one PiP is shown for purposes of example in FIG. 17, other embodiments may include more than one PiP, each of a different zoomed-in or detailed image of a portion of the larger image and showing other aircraft or traffic. Embodiments may be configured to determine which portions of the larger image to present as a PiP, for example based on proximity or other relevance (e.g., heading) with respect to the aircraft 10, and/or a predetermined number N of aircraft or PiPs. Customizable filters, for example selected by the pilot and stored by the user customizations 104 of the storage component 55, may be used to provide these and other PiP functionality described herein.

In the embodiments illustrated in FIG. 17, and as shown by the legend 982, surrounding aircraft that are on the ground (e.g., ground traffic) may be represented by a first symbol in the form of a diamond outline box having a first color, such as blue. Surrounding aircraft that are in flight (e.g., air traffic) may be represented by a second symbol in the form of a diamond outline box having a second color, such as red. Surrounding aircraft that are currently participating in audio comms communications may be represented by a third symbol in the form of a diamond outline box having a third color, such as green (e.g., highlighted audio communication traffic). The different aspects or characteristics of the different surrounding aircraft can thereby be differentiated by the different symbols used in connection with the associated surrounding aircraft identifiers. Also shown in the legend 982 is a symbol in the form of a series of adjacent box outlines defining a path or track that can represent a path of a surrounding aircraft (e.g., aircraft track).

The image 980 includes surrounding aircraft identifiers 983 and 985-987 showing the locations of four aircraft on the ground. Following the legend 982 described above, the surrounding aircraft identifiers 983 and 985-987 include blue diamond outline boxes 993 and 995-997, respectively, at the locations of the surrounding aircraft. Surrounding aircraft identifier 984 including a green diamond outline box 994 is shown at the location of the surrounding aircraft in the image 280, indicating that the associated surrounding aircraft is in audio comms communication, for example with another aircraft or the tower at the airport. The use of the green diamond outline box, which may be displayed concurrently with the presentation of the audio comms in the aircraft 10 (e.g., though the pilots headset), enables the pilot of the aircraft 10 to identify which aircraft the tower or other audio comms are referring to. Also shown is a surrounding aircraft identifier 963 including a red diamond outline box 964 at the location of that surrounding aircraft, in flight, and a track indicator 965 showing the direction of that aircraft in flight. Detailed image 981 includes a surrounding aircraft identifier 950 at the location of an aircraft on the ground, and includes a text box 952 that identifies that surrounding aircraft by its tail number, and provides the distance to and the altitude difference between that surrounding aircraft.

FIG. 18 is an exemplary image 300 of a live streaming image with a surrounding aircraft identifier annotation in accordance with embodiments. The image 300 includes a surrounding aircraft identifier 301 having an arrow 302 pointing in the direction of a surrounding aircraft that is outside the FOV of the image, and a text box 303 identifying that surrounding aircraft (“N9235C”) and its distance (“1.3 nm”) from the aircraft 10. The information presented in the text box 303, as well as in other text boxes and information displays described herein, can be customized based on selections and settings by the pilot and/or other selected criteria such as proximity to the aircraft 10. Examples of the types of information that can be presented include one or more of speed, direction, altitude difference, track and intention of the surrounding aircraft. These selected configurations may be stored by the user customizations 104 of the storage component 55.

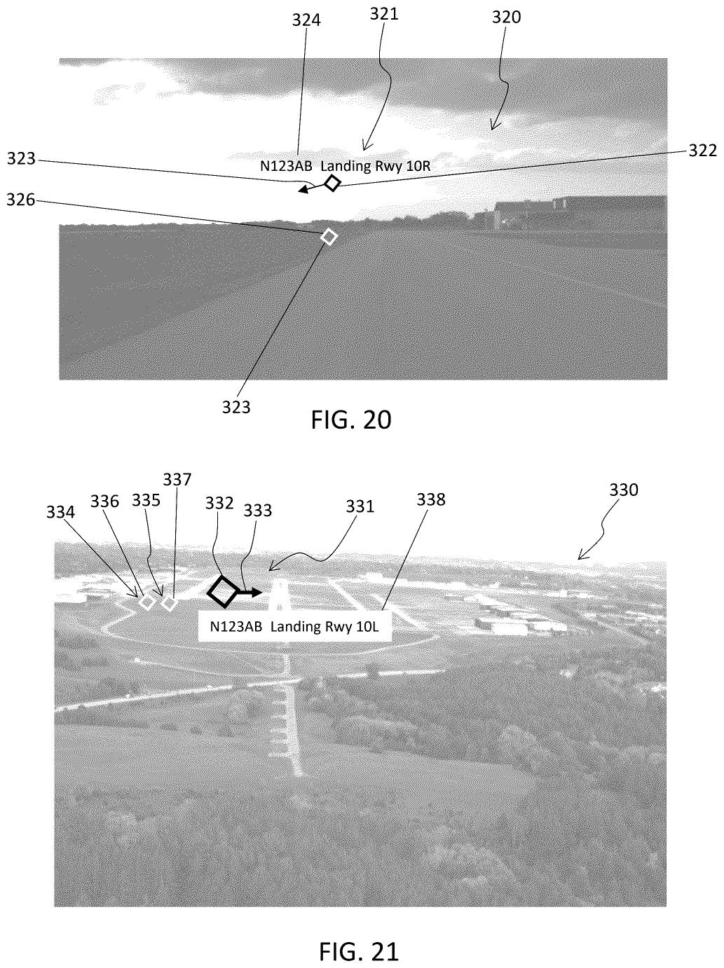

FIG. 19 is an exemplary image 310 of a live streaming image with a surrounding aircraft identifier annotation in accordance with embodiments. The image 310 includes a surrounding aircraft identifier 311 including a green diamond shape outline 312 at the in-flight location of that surrounding aircraft, indicating that it is the subject of current comms, and a track indicator 313 in the form of an arrow showing that surrounding aircraft's intention by indicating its direction of travel. The illustrated surrounding aircraft identifier 311 also includes a text box 314 identifying that surrounding aircraft (“N123AB”) and its intention of taking off from runway “14.” FIG. 20 is an exemplary image 320 of a live streaming image with surrounding aircraft identifier annotations in accordance with embodiments. The image 320 includes a surrounding aircraft identifier 321 including a green diamond shape outline box 322 at the in-flight location of that surrounding aircraft, indicating that it is the subject of current comms, and a track indicator 323 in the form of an arrow showing that surrounding aircraft's intention by indicating its direction of travel or track. The illustrated surrounding aircraft identifier also includes a text box 324 identifying that surrounding aircraft (“N123AB”) and its intention of landing on runway “10R.” Surrounding aircraft identifier 325 in form of a blue diamond shape outline box 326 is located on the image 320 at a location corresponding to the location of that on-ground surrounding aircraft.

FIG. 21 is an exemplary image 330 of a live streaming image with surrounding aircraft identifier annotations in accordance with embodiments. The image 330 includes a surrounding aircraft identifier 331 including a green diamond shape outline box 332 at the in-flight location of that surrounding aircraft, indicating that it is the subject of current comms, and a track indicator 333 in the form of an arrow showing that surrounding aircraft's intention by indicating its direction of travel. The illustrated surrounding aircraft identifier 331 also includes a text box 338 identifying that surrounding aircraft (“N123AB”) and its intention of landing on runway “10L.” Surrounding aircraft identifiers 334 and 335 in the form of blue diamond shape outline boxes 336 and 337, respectively, are located on the image 330 at locations corresponding to the locations of the on-ground surrounding aircraft.

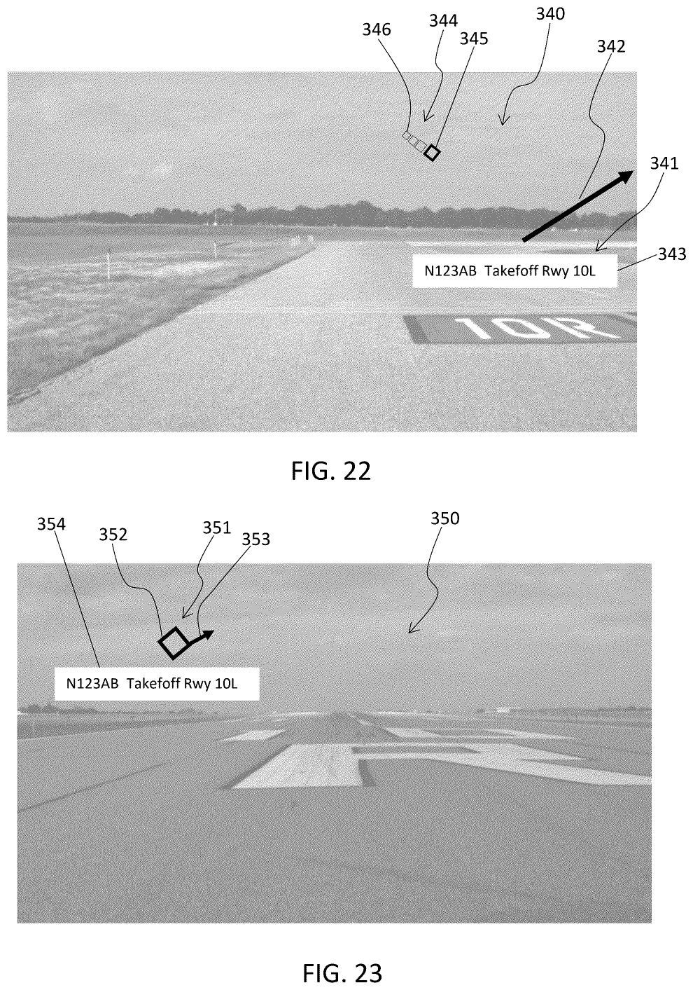

FIG. 22 is an exemplary image 340 of a live streaming image showing a FOV in front of an aircraft 10 on a taxiway approaching a runway labeled “10R” with surrounding aircraft identifier annotations in accordance with embodiments. The image 340 includes a surrounding aircraft identifier 341 having a green arrow 342 pointing in the direction of a surrounding aircraft that is outside the FOV of the image, and a text box 343 identifying that surrounding aircraft (“N123AB”) and its intention to take off from runway “10L.” Features such the arrow 342 and aircraft identifier in the text box 343 are displayed in green text to indicate that they are associated with a surrounding aircraft that is the subject of current comms, and those comms may be concurrently presented to the pilot in the aircraft 10. Also shown is a surrounding aircraft identifier 344 including a red diamond shape outline box 345 at the location of that in-flight surrounding aircraft, and a track indicator 346 showing the direction of that aircraft in flight.

FIG. 23 is an exemplary image 350 of a live streaming image showing a FOV in front of an aircraft 10 that has just entered a runway labeled “10R,” with surrounding aircraft identifier annotations in accordance with embodiments. The image 350 includes a surrounding aircraft identifier 351 including a green diamond shape outline box 352 at the on-ground location of that surrounding aircraft, indicating that it is the subject of current comms, and a track indicator 353 in the form of an arrow showing that surrounding aircraft's intention by indicating its direction of travel. The illustrated surrounding aircraft identifier also includes a text box 354 identifying that surrounding aircraft (“N123AB”) and its intention of taking off from runway “10L.”

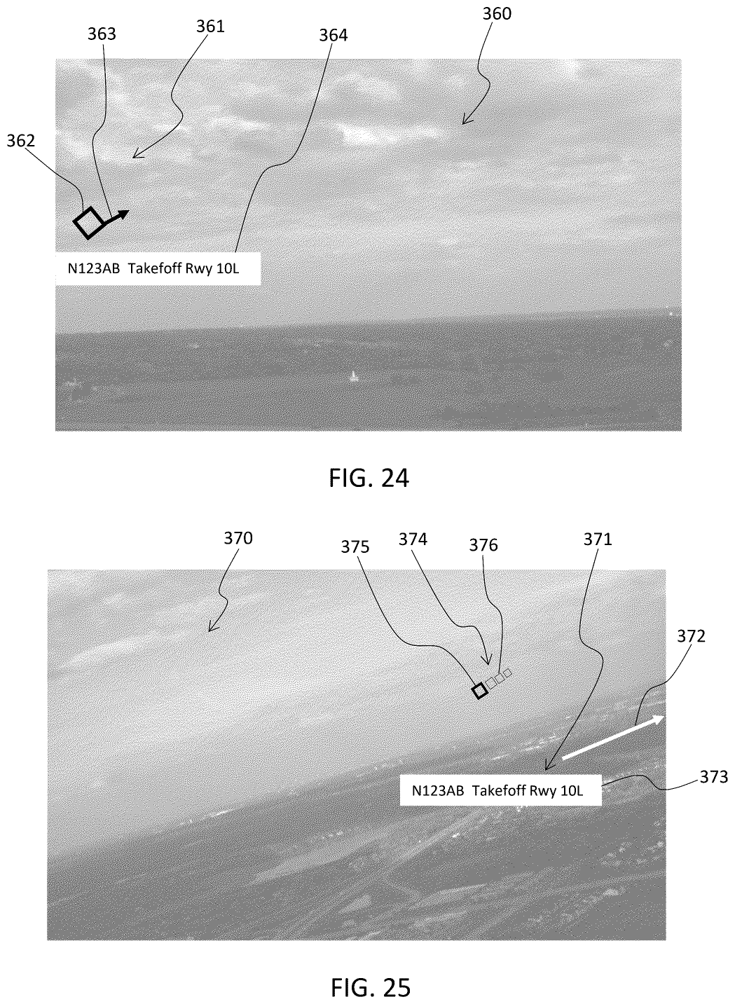

FIG. 24 is an exemplary image 360 of a live streaming image showing a FOV in front of an aircraft 10 in flight near an airport, with a surrounding aircraft annotation in accordance with embodiments. The image 360 includes a surrounding aircraft identifier 361 including a green diamond shape outline box 362 at the in-flight location of that surrounding aircraft, indicating that it is the subject of current comms, and a track indicator 363 in the form of an arrow showing that surrounding aircraft's intention by indicating its direction of travel. The illustrated surrounding aircraft identifier also includes a text box 364 identifying that surrounding aircraft (“N123AB”) and its intention of having taken off from runway “10L.” Presenting information about a surrounding aircraft's intention (e.g., what the aircraft is going to do), may be important to the pilot of aircraft 10. Knowledge of the intentions of surrounding aircraft may be determined, for example from audio information broadcast from the surrounding aircraft.

FIG. 25 is an exemplary image 370 of a live streaming image showing a FOV in front of an aircraft 10 in flight near an airport, with surrounding aircraft annotations in accordance with embodiments. The image 370 includes a surrounding aircraft identifier 371 having an arrow 372 pointing in the direction of a surrounding aircraft that is outside the FOV of the image, and a text box 373 identifying that surrounding aircraft (“N123AB”) and its intention to take off runway “10L”. Other information, including for example the distance to the surrounding aircraft, can also be included in the display. As described above, the particular types of information included in the text box can be customized. Features such the arrow 372 and aircraft identifier are displayed in green to indicate that they are associated with a surrounding aircraft that is the subject of current comms, and those comms may be concurrently presented to the pilot in the aircraft 10. Also shown is a surrounding aircraft identifier 374 including a red diamond shape outline box 375 at the location of that in-flight surrounding aircraft, and a track indicator 376 showing the direction of that aircraft in flight.

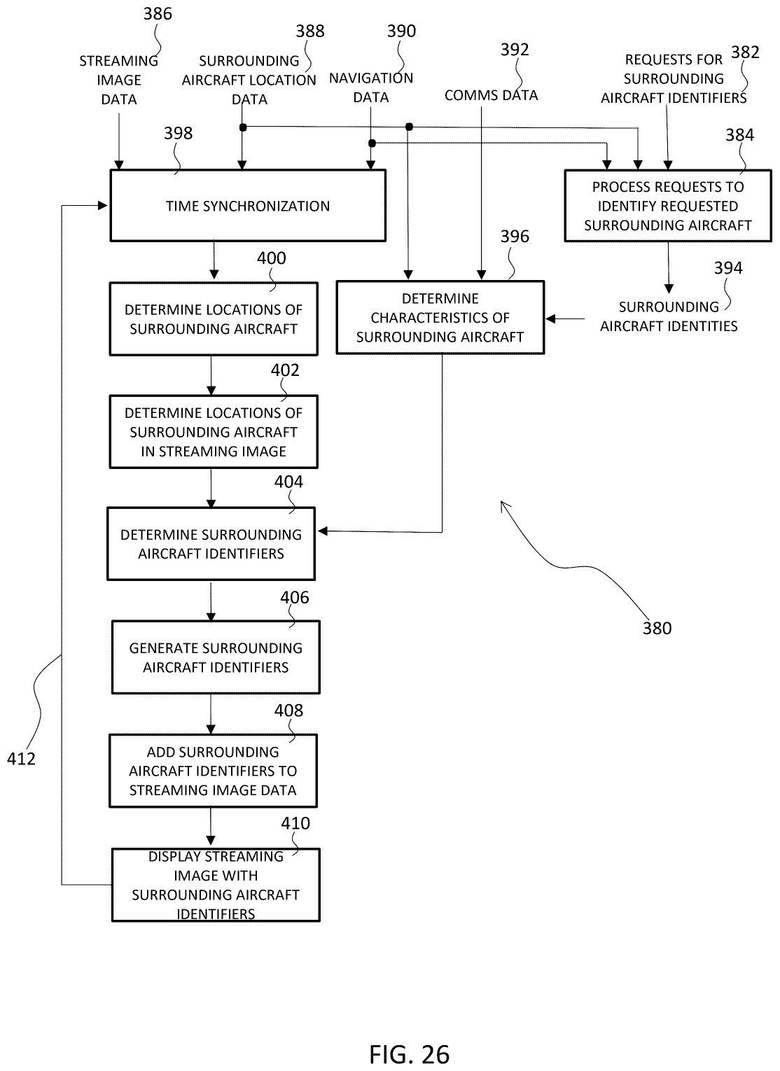

FIG. 26 is a diagrammatic illustration of a method 380 for generating an aircraft display including streaming images with surrounding aircraft annotations in accordance with embodiments. All or some of the steps of the method 380 can, for example, be performed by the avionics system 50 described in connection with FIG. 3 and its navigation and display system processing component 53 and storage component 55 described in connection with FIG. 4. Alternatively or additionally, all or some of the steps of method 380 can be performed off the aircraft, for example by the computing system 36 and/or navigation information sources 38 (e.g., in the cloud), and the associated data and information communicated to and from the aircraft via the communication system 30. The following description of the method 380 includes exemplary references to the avionics system 50 and its components 53 and 55, and to the communication system 30, computing system 36 and navigation information sources 38.

As shown in FIG. 26, the method 380 receives as inputs one or more of requests for surrounding aircraft identifiers (step 382), the streaming image information, each of a FOV from the aircraft 10 (step 386), surrounding aircraft location information (step 388), navigation information of the aircraft (step 390) or comms information (step 392). The streaming image information received at step 386 may, for example, be received from one or more of the video cameras on the aircraft 10, such as the forward-facing camera 66 or the rear-facing camera 68.

The surrounding aircraft location information received at step 388 may be one or more of the ADS-B information such as that received by radios 56 or radar information such as that received by radar 74. The navigation information may, for example, be received from one or more of the GPS receiver 70 or the IMU 72. The comms information, which may for example be ATC or aircraft-aircraft communications, may be received by radios 56.

Method 380 may be initiated in response to requests for surrounding aircraft annotations to be added to the streaming image display (step 382). For example, the surrounding aircraft annotation request may include one or more of (1) a request for surrounding aircraft at a location, for example near an airport by IATA code, or near the aircraft 10, (2) a request for a specific surrounding aircraft, for example by the aircraft tail no., or (3) a general request to activate the surrounding aircraft annotation feature of the avionics unit 52. In embodiments, the surrounding aircraft request is an audible or verbal request, for example received by the microphone 57 when the pilot speaks. Additionally or alternatively, the surrounding aircraft annotation request may be received by user actuation of a user interface such as that provided by the control component 62 of display 58 (e.g., by touch or gesture). In yet other embodiments, surrounding aircraft identifier requests by step 382 may effectively be performed automatically. For example, a pilot may have stored information that causes certain surrounding aircraft identifiers, such as for example, surrounding aircraft within a predetermined distance, or on the ground at airports, to be received by step 382. The automatic receipt of surrounding aircraft annotation requests by this approach may, for example, be configured by a pilot-selected theme or other user customization stored, for example in the user customizations 104 of the storage component 55.

At step 384, method 380 processes the surrounding aircraft identifier requests of step 382, if necessary or appropriate, to determine the identities 394 (e.g., tail numbers) of the surrounding aircraft of interest in the requests. For example, if the requests at step 382 are audible requests, the navigation and display system processing component 53 may perform natural language processing (NLP) on the audible requests to identify the surrounding aircraft from the audible portions of the request by step 384. In embodiments, the NLP can include a multistep approach by first converting the audible request to text form, for example by speech recognition processing component 83, and then parsing the text form of the request, for example by the information extraction processing component 85, to determine the identity 394 of the requested surrounding aircraft. In response to requests 382 where the specific identity of the aircraft is included in the request, the identity of the requested surrounding aircraft may be determined from the audio request alone by step 384.

In other situations of the type described above, the request for surrounding aircraft annotations may be more general, and may not include the identity of the requested surrounding aircraft. For example, if the request for an identifier of a surrounding aircraft is based on the location of the surrounding aircraft with respect to the aircraft 10 from which the request originated (e.g., does not include the aircraft tail no.), additional information such as the surrounding aircraft location information (step 388) and/or the navigation information 390 may be used to identify the requested surrounding aircraft. For example, based upon the surrounding aircraft location data and the navigation data, the navigation and display system processing component 53 can determine the identities of specific surrounding aircraft in response to requests that state the relative location of the surrounding aircraft of interest (e.g., “at 3:00,” “below” or “on final”). In addition to the NLP processing described above, the navigation and display system processing component 53 may use the vector component 84 in connection with the identification of surrounding aircraft at step 384.

As shown by step 396, embodiments of the method 380 include determining information representative of the nature or other characteristics of the surrounding aircraft.

Examples of surrounding aircraft characteristics that may be determined at step 396 include the direction or heading, velocity, or altitude of the surrounding aircraft, whether or not the surrounding aircraft is the subject or participating in comms, and/or intentions of the surrounding aircraft such as whether it is taxiing to takeoff (optionally at a specific runway) or whether it is on approach to landing (optionally at a specific runway). One or more of the characteristics such as direction, velocity or altitude of the surrounding aircraft may be determined from the ADS-B data or other surrounding aircraft location information received at step 388. Other characteristics of the surrounding aircraft such as its intentions may be determined from the comms information received at step 392. In embodiments, the navigation and display system processing component 53 may determine intentions or other characteristics of the surrounding aircraft by NLP processing the comms information, for example using the speech recognition component 83 and information extraction component 85.

At step 398, one or more of the streaming image information (from step 386), the surrounding aircraft location information (from step 388) and the navigation information (from step 390) are time synchronized, as needed or appropriate. For example, the streaming image information, surrounding aircraft location information and navigation information may include time stamp information representative of the time that the information was captured or received. Accuracy of the information such as the characteristics of the surrounding aircraft included in the surrounding aircraft identifiers generated by the method 380, and the accuracy of positional locations of the surrounding aircraft identifiers on the displayed streaming image, can be enhanced by sufficiently time-synchronizing the information at step 398. The time synchronization by step 398 may, for example, be performed by the preprocessing component 81 of the navigation and display system processing component 53. In embodiments, the preprocessing component 81 may also perform other preprocessing of the streaming image information (from step 386), the surrounding aircraft location information (from step 388) and the navigation information (from step 390), for example to format the information in manners that facilitate efficient processing during subsequent steps of the method 380.

At step 400, method 380 determines the locations of surrounding aircraft. The locations of the surrounding aircraft can, for example, be the geo locations and altitudes of surrounding aircraft determined from the ADS-B and/or other surrounding aircraft location information. In some embodiments, locations of surrounding aircraft are determined at step 400 for aircraft identified at step 394 in response to requests for surrounding aircraft identifiers. Surrounding aircraft locations may be determined, for example, for specific surrounding aircraft that are the subject of requests, all surrounding aircraft within a predetermined distance of the aircraft 10, a predetermined number of closest surrounding aircraft, and/or surrounding aircraft in a particular direction (e.g., at 12:00 or 3:00) with respect to the aircraft 10.

At step 402, method 380 determines the locations of the surrounding aircraft in the streaming image. By this step 402, the method can determine the locations on the streaming image at which the associated surrounding aircraft identifiers can be displayed on the streaming image. For example, the locations of surrounding aircraft identified by symbols or other features such as diamond outline boxes shown in FIGS. 17-25 can be identified. In embodiments, vector processing based on the locations of the surround aircraft determined at step 400 and the location of the aircraft 10 represented by the navigation information received at step 390, such as that performed for example by the vector component 84, can be performed by method 380 to determine the locations of the surrounding aircraft 14 in the streaming images.

At step 404, method 380 determines the type of identifier to be displayed for the surrounding aircraft in the streaming image display. As shown, determining the type of surrounding aircraft identifier at step 404 may be based upon the characteristics of the associated surrounding aircraft such as those determined at step 396. Information defining the type of surrounding aircraft identifier may be determined at step 404, for example, by accessing the annotation feature maps 193 of the storage component 55. The annotation feature maps 193 may, for example, include templates or other data structures associated with the different types of characteristic information to be included in the surrounding aircraft identifier. Examples of such templates include the diamond shape outline boxes to circumscribe, the colors of the shape outline boxes, and arrows pointing to, the locations of the surrounding aircraft, and the text boxes listing the tail number or other identifier of the surrounding aircraft (e.g., box 993 of surrounding aircraft identifier 983 in FIG. 17, and arrow 302 and text box 303 of surrounding aircraft identifier 310 in FIG. 18). Other embodiments use other symbols or features, such for example pins or lines pointing to the surrounding aircraft. Examples of templates to reflect the characteristic information to be presented by surrounding aircraft identifiers includes the color codes of the surrounding aircraft identifiers described above in connection with the legend 282 shown in FIG. 17, and text boxes, arrows and track indicators describing intentions of the surrounding aircraft such as those shown in FIGS. 22 and 23.

At step 406, method 380 generates the surrounding aircraft identifier. In embodiments, at step 406 the surrounding aircraft identifier can be generated based upon the information associated with the surrounding aircraft, including its characteristics, and the template or other identifier information determined by step 404. For example, the surrounding aircraft identifiers 321 and 331 shown in FIGS. 20 and 21, respectively, can be generated by color coding the associated diamond shape outline boxes 322 and 332 and aircraft tail number in text boxes 324 and 338 green to indicate that they are the subject of comms by ATC, and to include their landing intentions in text boxes.

At step 408, the surrounding aircraft identifiers generated by step 406 are added to the streaming image information at the appropriate location determined by step 402. The video information defining the streaming image with the surrounding aircraft identifier annotations is then displayed, for example by the image component 60 of the display 58, as shown by step 410.

Steps of the method 380 that are needed or otherwise appropriate to cause the surrounding aircraft identifier annotations to be displayed at step 410 as the streaming image is displayed in real time may be repeated. For example, if the aircraft 10 is in flight, the FOV of the streaming image will continuously change with the motion of the aircraft. Similarly, if the surrounding aircraft are moving, their locations in the FOV of the streaming image will change. Steps of the method 380 needed to continue to add the surrounding aircraft identifiers to the streaming image at the appropriate locations in the streaming image are repeated, as indicated generally by step 412. In embodiments, one or more portions of the method 380 may not be needed in maintain the display of the surrounding aircraft identifier annotations on the streaming image by step 412. For example, after the nature of the identifier is determined for the surrounding aircraft at step 404 and the associated identifier is generated at step 406, the identifier generated by those steps may be resized and effectively reused as appropriate for changes to the scale of the FOV and/or movement of the surrounding aircraft, and added to the streaming image at step 408 without the need to reperform those steps. However, as characteristics of the surrounding aircraft change (e.g., the aircraft is no longer the subject of comms or it changes from on-ground to in-flight after a takeoff), the associated surrounding aircraft identifier will be updated in accordance with the aircraft identifiers.

Avionics systems and methods that provide surrounding aircraft annotations of these types can provide important advantages. For example, showing traffic information while flying can help pilots with surrounding aircraft traffic awareness, seeing where the traffic could be located, and maintaining proper spacing between one's aircraft and traffic. The ability to visually identify traffic in the air and to make a proper determination of where in real space the traffic is located can be especially helpful to pilots. The disclosed embodiments can help a pilot quickly and accurately localize traffic.

Embodiments include displaying surrounding aircraft information, such as that obtained from ADS-B, on live camera views for use in General Aviation (GA) aircraft. The display may show traffic in the pilot's FOV (field of view), and may indicate where to look when traffic is outside the FOV. Traffic location may be highlighted, for example by using different colored diamonds. On live camera views, technology in accordance with these embodiments can show where in real space the pilot should look to find the aircraft outside of the front facing FOV. In addition, the display can indicate callsign, display a zoomed in PiP (picture in picture) view of certain aircraft, and/or display relative altitude and aircraft track. All or portions of the display are customizable for pilot display preferences. For example, features can be added or removed depending on what is helpful to each specific pilot for locating traffic. Aircraft on the ground may be displayed in a separate color.

A possible problem addressed by this technology relates to issues when the pilot is unable to see aircraft outside their FOV. With the live camera displays, the display will show the pilot what direction to look if traffic is not directly in front. At least some traffic separation issues in visual flight rule (VFR) conditions is vision based. This becomes the pilot's responsibility to maintain proper separation between aircraft and traffic. Being able to identify the traffic ahead of time by being directed where to look may be a safety enhancement. This approach can reduce issues relating to the problem of having to locate exactly where an aircraft is when outside a FOV. Live camera views, as opposed to conventional top down two dimensional and synthetic world view, may allow pilots to use real-time context from the environment, such as clouds, sun angle, trees, etc., to help quickly and accurately identify traffic outside of the cockpit by using these features from the live display to efficiently search.

Another possible problem that can be addressed by this technology relates to the issue of not knowing which traffic ATC is talking about (e.g., in controlled airspace) or which traffic is transmitting on the comms (e.g., in uncontrolled airspace). There may be confusion when flying and trying to identify which aircraft ATC or comms is referring to. This may take time and may not be highly accurate. For example: if ATC says “Cirrus N123AB, there is traffic at your three o'clock, five miles, an A320 at three thousand feet. Report traffic in sight,” it may take a pilot a relatively long time to look in the right direction, and peer out into the clouds, looking for a moving element, especially if relatively small in the FOV, that is the correct traffic. In a busy airspace, this can become more difficult, as a pilot is trying to identify more traffic, and there is a higher probability of identifying the wrong traffic. Having to search the air for traffic may also take time away from other pilot functions, such as piloting the aircraft, navigation, landing, weather reroutes, etc. With the disclosed display technology, the NLP model can identify which aircraft audio communication is referring to or associated with, and then this information is fed into the surrounding traffic overlays, allowing the pilot to quickly and accurately identify the specified traffic.

Yet another potential problem that can be addressed by the disclosed display technology relates to understanding traffic intention. Even if a pilot locates traffic while in the cockpit, it can still be difficult to deduce what the traffic's intention is. For example: ATC may give a cleared for takeoff to a surrounding aircraft: “N123AB you are cleared for take-off runway one two left.” If in this example an aircraft configured to include streaming image displays with surrounding aircraft annotations is on final on runway 12R, the display may show N123AB being highlighted on runway 12L, and it's intended vector, which is to take off on that runway. This shows to the pilot that the traffic near to their aircraft is not on a collision course. The pilot is landing on 12R, and the intention of the traffic is to take off on 12L, thus the pilot can deduce it is safe to land in regard to traffic.

One example of the surrounding aircraft annotation embodiments is a method, for example performed by one or more processors. Steps of the method may comprise: receiving, from a camera on the aircraft, a streaming image from the aircraft; receiving navigation information representative of the location and orientation of the aircraft; receiving surrounding aircraft information associated with each of one or more surrounding aircraft; determining, based upon the navigation information and the surrounding aircraft information, a location of each of the one or more surrounding aircraft with respect to the streaming image; generating a surrounding aircraft identifier for each of the one or more surrounding aircraft; generating a surrounding aircraft-annotated streaming image based upon the streaming image and including each surrounding aircraft identifier, wherein each surrounding aircraft identifier is at a location in the surrounding aircraft-annotated streaming image corresponding to the location of the associated surrounding aircraft; and displaying the surrounding aircraft-annotated streaming image in the aircraft.

In some embodiments of the method, the surrounding aircraft information includes one or more of (1) information received from the surrounding aircraft, optionally Automatic Dependent Surveillance—Broadcast (ADS-B) information, (2) communication information from the surrounding aircraft, (3) information generated by a sensor on the aircraft, optionally radar information, or (4) information received from a ground-based source, optionally Air Traffic Control (ATC) information.

In any or all of the above embodiments, the method further comprises determining, based upon the surrounding aircraft information, one or more aircraft characteristics relating to one or more characteristic-associated aircraft of the one or more surrounding aircraft, wherein the one or more aircraft characteristics includes one or more aircraft characteristics from a group including ground traffic, air traffic, audio, or track; and generating the surrounding aircraft identifier for each of the one or more characteristic-associated aircraft includes generating a surrounding aircraft identifier representative of the determined aircraft characteristic.

For example, receiving the surrounding aircraft information can include receiving, and presenting in the aircraft concurrently with the receipt, audio information relating to each of one or more audio-associated aircraft of the surrounding aircraft determined to have an audio characteristic, wherein the audio information optionally includes one or more of communication information from the surrounding aircraft or Air Traffic Control (ATC) information; generating the surrounding aircraft identifier for each audio-associated aircraft includes generating an audio surrounding aircraft identifier representative of the audio characteristic; and displaying the surrounding aircraft identifier for each audio-associated aircraft includes displaying the associated audio surrounding aircraft identifier concurrently with the presentation of the associated audio information. Generating the surrounding aircraft identifier for each audio-associated aircraft may, for example, include generating a highlighted surrounding aircraft identifier during the presentation of the associated audio information.

As another example, receiving the surrounding aircraft information can include receiving track information relating to a vector of motion for each of one or more track-associated aircraft of the surrounding aircraft determined to have a track characteristic; generating the surrounding aircraft identifier for each track-associated aircraft includes generating a track surrounding aircraft identifier representative of the vector of motion of the aircraft; and displaying the surrounding aircraft identifier for each track-associated aircraft includes displaying the associated track surrounding aircraft identifier.

As another example, receiving the surrounding aircraft information can include receiving ground traffic information for each of one or more ground traffic-associated aircraft of the surrounding aircraft determined to have a ground traffic characteristic; generating the surrounding aircraft identifier for each ground traffic-associated aircraft includes generating a ground traffic surrounding aircraft identifier representative of the ground characteristic of the aircraft; and displaying the surrounding aircraft identifier for each ground traffic-associated aircraft includes displaying the associated ground traffic surrounding aircraft identifier.

As another example, receiving the surrounding aircraft information includes receiving air traffic information for each of one or more air traffic-associated aircraft of the surrounding aircraft determined to have an air traffic characteristic; generating the surrounding aircraft identifier for each air traffic-associated aircraft includes generating an air traffic surrounding aircraft identifier representative of the air traffic characteristic of the aircraft; and displaying the surrounding aircraft identifier for each air traffic-associated aircraft includes displaying the associated air traffic surrounding aircraft identifier.

In any or all of the above embodiments, the method further comprises determining, based upon the navigation information and the surrounding aircraft information, a limited set of surrounding aircraft for identification; and displaying the surrounding aircraft identifier includes displaying the surrounding aircraft identifier for only the surrounding aircraft in the limited set of surrounding aircraft. For example, determining the limited set of surrounding aircraft for identification may include determining the limited set of aircraft based upon one or more of a maximum number of surrounding aircraft, a distance of the surrounding aircraft from the aircraft, or a location of the surrounding aircraft with respect to the aircraft (e.g., at 3:00 or otherwise outside a FOV in front of the cockpit).

In any or all of the above embodiments, determining the location of each of the one or more surrounding aircraft may include determining that at least one of the surrounding aircraft is outside a field of view of the streaming image; and generating the surrounding aircraft-annotated streaming image includes generating the surrounding aircraft-annotated streaming image including the surrounding aircraft identifier for each of the at least one surrounding aircraft outside the field of view of the streaming image at a location in the surrounding aircraft-annotated streaming image, optionally a side of the surrounding aircraft-annotated streaming image.

In any or all of the above embodiments, determining the location of each of the one or more surrounding aircraft includes determining that at least one of the surrounding aircraft is within a field of view of the streaming image; and generating the surrounding aircraft-annotated streaming image includes generating the surrounding aircraft-annotated streaming image including the surrounding aircraft identifier for each of the at least one surrounding aircraft within the field of view at the location of the associated surrounding aircraft in the surrounding aircraft-annotated streaming image.

In any or all of the above embodiments, the surrounding aircraft identifier may include one or more of (1) aircraft call sign, (2) a feature circumscribing all or part of the aircraft, (3) a feature defining aircraft intention, (4) a feature defining a track or direction, (5) aircraft velocity, (6) a feature indicating an on-ground nature, (7) a feature indicating an in-flight nature, (8) a feature indicating that the aircraft is engaged in audio communications, (9) a text box including aircraft intention, (10) relative altitude between the ownship aircraft and traffic, or (11) distance to traffic.

In any or all of the above embodiments, the method may further comprise: generating, optionally based upon the streaming image, a zoomed-in streaming image of a portion of the FOV of the streaming image including one or more of the surrounding aircraft; generating a surrounding aircraft-annotated zoomed-in streaming image including each surrounding aircraft within a field of view of the surrounding aircraft-annotated zoomed-in streaming image at a location in the surrounding aircraft-annotated zoomed-in streaming image corresponding to a location of the associated surrounding aircraft; and displaying the surrounding aircraft-annotated zoomed-in streaming image. For example, displaying the surrounding aircraft-annotated zoomed-in streaming image my include displaying the surrounding aircraft-annotated zoomed-in streaming image as a picture in picture (PiP) in the displayed surrounding aircraft-annotated streaming image, which may enhance the pilot's ability to see traffic.

In any or all of the above embodiments, receiving the navigation information includes receiving the navigation information from one or both of a GPS receiver or an IMU on the aircraft.

In any or all of the above embodiments, receiving the streaming image may include receiving a streaming image of a field of view in front of a cockpit of the aircraft. For example, displaying the surrounding aircraft-annotated streaming image may include displaying the surrounding aircraft-annotated streaming image on a visual display in a cockpit of the aircraft.

Another example of the surrounding aircraft annotation embodiments comprises a computer system including one or more processors, and memory storing instructions that when executed by the one or more processors causes the one or more processors to perform the steps of any of the embodiments of the method described above.

Yet another example of the surrounding aircraft annotation embodiments comprises a non-transitory computer-readable medium storing instructions that, when executed by one or more processors of a computer system, causes the computer system to perform the steps of any of the embodiments of the method described above.

### Ground Feature Color Information Annotation Embodiments

Ground feature color information annotation embodiments include displaying visual annotations associated with color-based ground features (e.g., structures and/or regions of interest) of airports such as 12 on a displayed streaming image from an aircraft 10 that includes the airport. Systems such as those described generally with reference to FIGS. 2-4 can be configured to provide these ground feature color annotation embodiments, for example in aircraft 10 operating in environments such as 8 described with reference to FIG. 1. In embodiments, the ground feature color annotations are located on the streaming image at a location corresponding to the location of the associated airport ground feature on the streaming image (e.g., adjacent or next to, such as above, below, or on the side of the color-based airport ground feature). By these embodiments, the airport ground feature annotations are overlayed onto the live streaming image. Examples of color-based ground features that can be the subject of the color annotations include the precision approach path indicator (PAPI) system 16 at the airport 12 shown in FIG. 1 and signal lights such as those presented at traffic control towers (not visible in FIG. 1).

The display may include a live streaming image from a video camera mounted on the aircraft. Image data from the camera may be processed by filters (e.g., electronic color filters) and algorithms. By one version, a region of the video image has its color remapped such that color tones that are difficult for the pilot to identify or distinguish are mapped to other color tones that may be easier for the pilot to distinguish. By another version, the camera position and orientation are used to compute a pose relative to the earth. Information from an airport database can be accessed and compared to the pose to determine airport features that may benefit from color remapping and/or symbol annotation. Examples of such airport information include National Airspace System Resource (NASR) information and Airport Data and Information Portal (ADIP) information from databases maintained and published by the U.S. Federal Aviation Administration (FAA). Examples of airport features that can be annotated in embodiments include visual approach slope indicators (VASI) and PAPI light systems, as well as rotating beacons, runway and taxiway lights and other signal lights such as those on air traffic control (ATC) signals. Visual regions associated with these airport features, and their associated color states, can be determined. Depending on the nature of the airport features and their color states, they can be mapped to alternative colors and/or symbols. For example, steady or flashing states can be indicated visually in a format that may not require the pilot to maintain visual focus on the feature itself to understand if the feature is steady or flashing. The color annotations, which are overlayed onto or substituted into the video or other camera image displayed to the pilot, include colorblind-friendly design patterns and/or color palates in embodiments. The color maps, symbols and other annotation features can be selected by the pilot in embodiments, and thereby tailored or optimized to the pilot's vision capabilities. The ground feature color annotations may improve situational awareness for all pilots, as well as provide routes for colorblind pilots to apply for exemptions to medical limitations on their licenses.

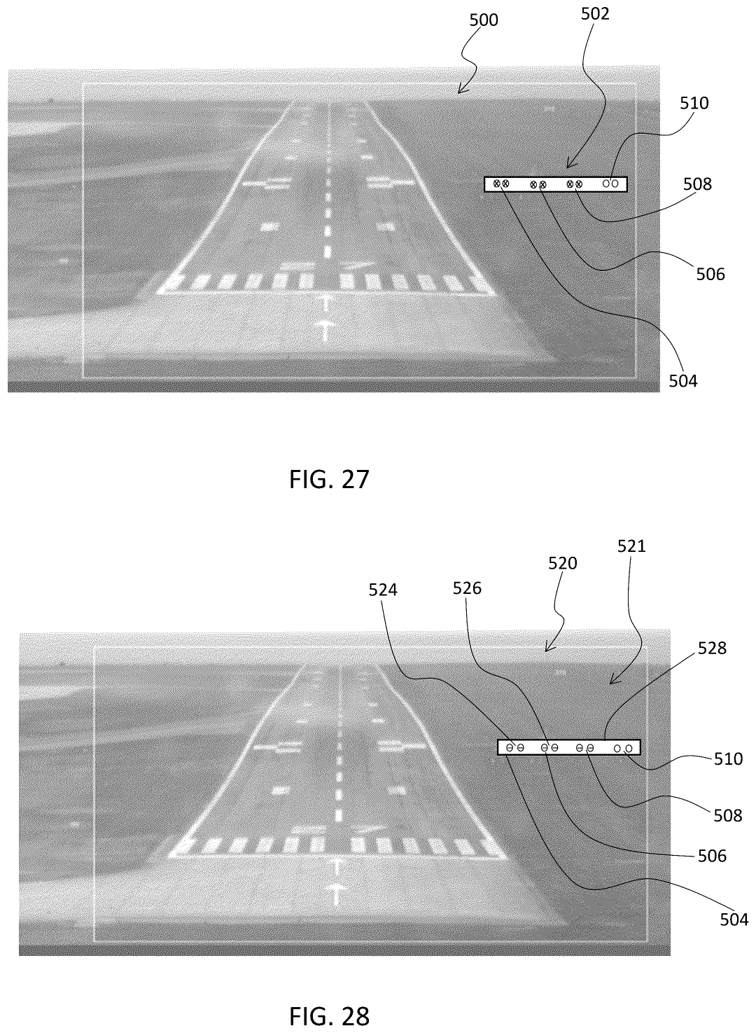

FIG. 27 is an exemplary image 500 (e.g., one still image) of a live streaming image generated from a video signal from a forward-facing camera in an aircraft approaching a leading end of a runway, and includes a FOV the pilot would see out the front of the aircraft from its cockpit. Image 500 includes an airport feature in the form of a runway with a PAPI system 502 that has four sets of lights 504, 506, 508 and 510. In original (e.g., un-annotated) image 500 generated by the camera, sets of lights 504, 506 and 508 have a red color state, and set of lights 510 have a white color state (e.g., conventional PAPI system colors, and as would be recognized by a non-colorblind pilot). However, in view of the greyscale nature of FIG. 27, the red color state of sets of lights 504, 506 and 508 is shown diagrammatically by the shape “x” in a circle, and the white color state of the set of lights 510 is shown diagrammatically by an unfilled circle. In effect, FIG. 27 is intended to represent an image without color feature annotations in accordance with the embodiments described here.

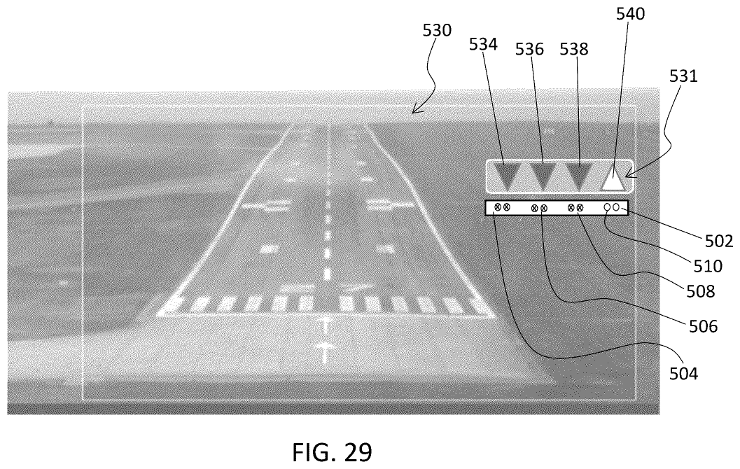

FIG. 28 is an exemplary image 520 of a live streaming image with ground feature color annotations in accordance with embodiments. Image 520 shows the same runway and PAPI system 502 shown in FIG. 27, but is annotated or color-remapped with a color annotation 521. A pilot with red-green color blindness may not be able to readily distinguish the red color states of sets of lights 504, 506 and 508 in the image 500 shown in FIG. 27. In the image 520 of FIG. 28, the PAPI system 502 is annotated with a color annotation 521 including overlays or annotations 524, 526 and 528 in connection with the sets of lights 504, 506 and 508, respectively. The color annotations 524, 526 and 528 are shown in the form of color regions at the locations of the sets of lights 504, 506 and 508, where the original red color state of the sets of lights is replaced with an alternative color state that is identifiable and distinguishable to the pilot, such as for example blue or purple. In embodiments, the alternative color state may be selected by the pilot, for example to be an alternative color that is distinct and understandable for that pilot. For example, Deuteranomaly and Protanomaly make red-green difficult to distinguish, so a shift toward yellow-blue may make colors more distinct for pilots with these color vision deficiencies. In embodiments, a user interface such as for example the control component 62 of the display 58 can be used to select (e.g., by the pilot) and configure the alternative colors used by the ground feature color information annotation embodiments, and the selected alternative colors can be stored by the user customizations component 104 of the navigation and display system processing component 53. Because of the greyscale nature of FIG. 28, the alternative color state of the annotations 524, 526 and 528 is shown diagrammatically by a horizontal line in an open circle. The embodiments shown in FIG. 28 do not include an annotation for the white set of lights 510, which is typically distinguishable by colorblind pilots.

FIG. 29 is an exemplary image 530 of a live streaming image with ground feature color annotations in accordance with embodiments. Image 530 shows the same runway and PAPI system 502 shown in FIG. 27, but is annotated or symbol-remapped with a color-based symbol annotation 531. Following the example above, a pilot with red-green color blindness may not be able to distinguish the red color states of sets of lights 504, 506 and 508 in the camera-generated image shown in FIG. 27. In the image 530 of FIG. 29, the PAPI system 502 is annotated with a symbol annotation 531 that includes symbols 534, 536, 538 and 540 in connection with the PAPI system. In the illustrated embodiments, the symbol annotation 531 is positioned adjacent to the PAPI system 502. For purposes of example, symbols 534, 536 and 538 that represent the originally red color state sets of lights 504, 506 and 508 are downwardly-pointing, black triangles. The symbol 540 that represents the originally white color state set of lights 510 is an upwardly-pointing white triangle.

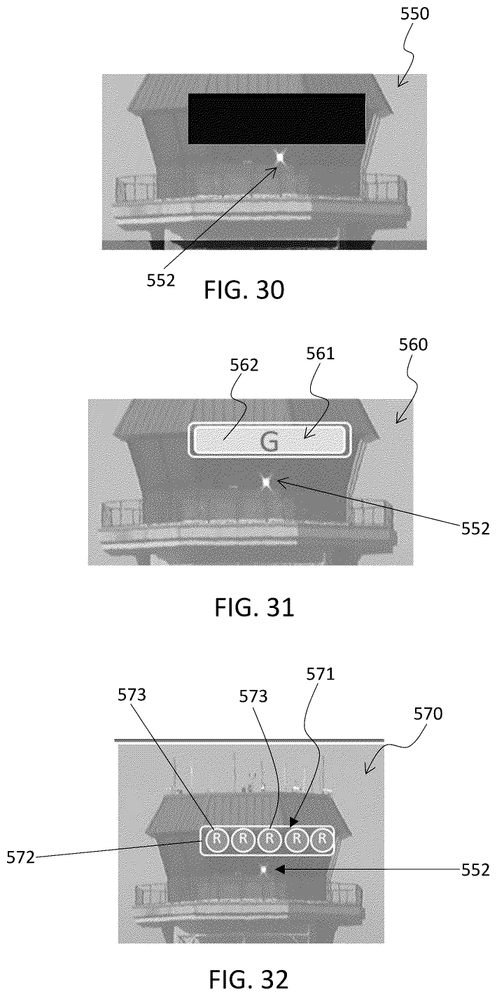

FIG. 30 is an exemplary image 550 of a live streaming image generated from a video signal from a forward-facing camera in an aircraft and includes a FOV the pilot would see out the front of the aircraft from its cockpit. Image 550 includes an airport feature in the form of a traffic control tower having a signal light 552. Signal lights such as 552 typically operate in one of a plurality of display states to display information to pilots. For example, the signal light 552 may operate in a plurality of different color and/or temporal states such as steady red, steady green and steady white color states, flashing red and flashing green color states, and alternating red and green color states. A flashing red light state may indicate that an aircraft should not land, and a steady green light state may indicate that an aircraft is cleared to land, for example.

FIGS. 31 and 32 are exemplary images 560 and 570 of live streaming images with ground feature color annotations in accordance with embodiments. Images 560 and 570 show the same traffic control tower and signal light 552 shown in FIG. 30, but are annotated with color-based symbol annotations 561 and 571, respectively, to illustrate the color and/or temporal states of the signal light 552. The FIG. 31 symbol annotation 561, which for example is configured to represent a steady green light state of the signal light 552, includes a text box 562 with a single letter representing the current color state of the signal light (“G” for green color in the illustrated embodiment). In embodiments, the text box 562 is filled with the color of the signal light 552 (e.g., green in this example). The FIG. 32 symbol annotation 571, which for example is configured to represent a flashing red light state of the signal light 552, includes a text box 572 with a plurality of shape outlines 573, with a single letter representing the color state of the signal light (“R” for red color in the illustrated embodiment). In the illustrated embodiments, the shape outlines 573, which are shown as circles for purposes of example in FIG. 32, are filled with the color of the signal light 552 (e.g., red in this example). Additionally or alternatively, the color state of the signal light 552 can be remapped in a manner similar to that described above in connection with FIGS. 27 and 28.

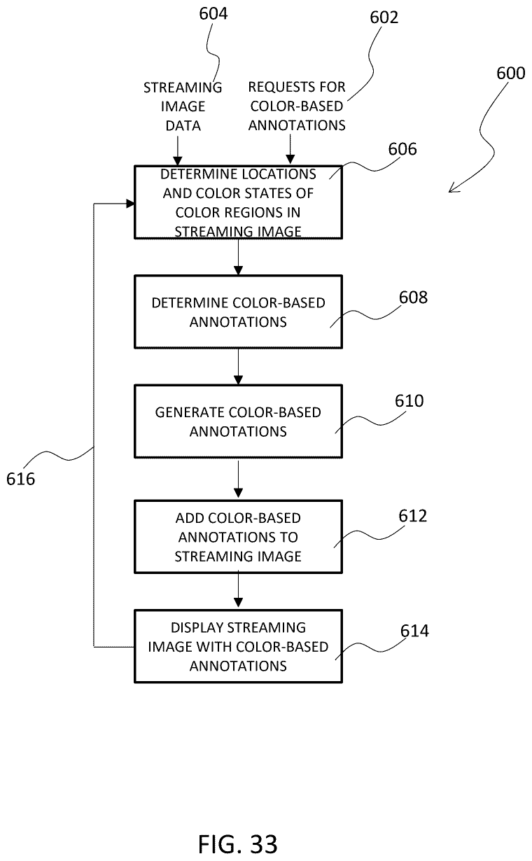

FIG. 33 is a diagrammatic illustration of a method 600 for generating an aircraft display including live streaming images with color-based ground feature annotations in accordance with embodiments. All or some of the steps of the method 600 can, for example, be performed by the avionics system 50 described in connection with FIG. 3 and its navigation and display system component and associated storage component 55 described in connection with FIG. 4. Alternatively or additionally, all or some of the steps of method 600 can be performed off the aircraft, for example by the computing system 36 and/or navigation information sources 38 (e.g., in the cloud), and the associated data and information communicated to and from the aircraft via the communication system 30. The following description of the method 600 includes exemplary references to the avionics system 50 and its components 53 and 55, and to the communication system 30, computing system 36 and navigation information sources 38.

As shown in FIG. 33, the method 600 receives as inputs one or more of requests for color-based annotations (step 602) and the streaming images, each of a FOV from the aircraft 10 (step 604). The streaming image information received at step 604 is received in embodiments from one or more of the video cameras on the aircraft, such as the forward-facing camera 66 or the rearward-facing camera 68. The method 600 may be initiated in response to requests for color-based feature annotations to be overlaid onto the streaming images at step 604. In embodiments, the color-based annotation request is an audible or verbal request, for example received by the microphone 57 when the pilot speaks. Additionally or alternatively, the color-based annotation request may be received by user actuation of a user interface such as that provided by the control component 62 of display 58 (e.g., by touch or gesture). In yet other embodiments, color-based annotation requests by step 602 may effectively be performed automatically. For example, the pilot may have stored configuration information that causes certain the color-based annotations, such as for example, airport light features within a predetermined distance and altitude (e.g., when the aircraft is on approach to a runway), to be received by step 602. The automatic receipt of color-based annotation requests by this approach may, for example be configured by a pilot-selected theme or other user customization stored, for example in the user customizations 104 of the storage component 55.

Although not shown in FIG. 33, method 600 may process the color-based annotation requests received at step 602, if necessary or appropriate. For example, if the requests at step 602 are audible requests, the navigation and display system processing component 53 may perform natural language processing (NLP) on the audible requests to identify the request and/or relevant information items in the request. In embodiments, the NLP can include a multistep approach by first converting the audible speech that includes the request into text form, for example by speech recognition component 83, and then parsing the text form of the speech to identify the request and associated information elements, for example by the information extraction component 85.

As shown by step 606, method 600 determines the locations and color states of color regions in the streaming image. In embodiments, step 606 is performed by identifying image information (e.g., pixel data) that corresponds to light having colors, such as for example red, green and white, that may be expected to be found on ground features at airports. Processing approaches such as color filtering and intensity thresholding and correlations can be used in connection with step 606, in embodiments. The process done at step 606 can also take into account knowledge that certain color-based ground features such as VASI and PAPI systems will have known arrangements of light elements (e.g., numbers and relative positioning). In embodiments, color filtering and intensity thresholding can be used in connection with the color state determination. Alternatively and/or additionally, artificial intelligence approaches such as a trained deep neural networks and/or convolutional neural networks can be used to locate certain color-based ground features such as VASI and PAPI systems (for example, with higher precision and to perform the lighting state classification.

At step 608, method 600 determines the type of color-based identifier or annotation to be displayed for the color regions identified at step 606. Determining the color-based annotation at step 608 can be based upon the color states determined at step 606. Information defining the color-based annotation may be determined, for example, by accessing annotation feature maps 193 of the storage component 55. In embodiments, the annotation feature maps 193 include color maps that map each of one or more first color states to a corresponding second color state. As an example, color maps of these types may map first color states that are difficult for colorblind pilots to distinguish to associated second color states that can be more readily distinguished by the pilots. In embodiments used by pilots that have red-green color blindness, for example, the color maps can for example map red and green color states to blue and yellow or blue and orange color states, respectively.

At step 610, method 600 generates the color-based annotation. In embodiments, at step 610 the color-based annotation can be generated based upon the information determined at step 608. For example, the color-based annotations generated at step 610 can be color regions having remapped color states determined from the color maps. Sizes of the color regions for the color-based annotations generated at step 610 can correspond to the sizes of the associated color regions determined at step 608, or be different in size (e.g., larger to enhance visibility).

At step 612, the color-based annotations generated by step 610 are added to the streaming image information at the appropriate location determined by step 606. For example, the color-based annotations generated by step 610 can be effectively substituted into the streaming image in place of the color regions determined by step 606 (e.g., at the corresponding pixels). The video information defining the streaming image with the color-based annotations is then displayed, for example by the image component 60 of the display 58, as shown by step 614.

Steps of the method 600 that are needed or otherwise appropriate to cause the color-based annotations to be displayed at step 614 as the streaming image is displayed in real time can be repeated. For example, if the aircraft 10 is in flight, the FOV of the streaming image will change. Steps of the method 600 needed to continue to add the color-based annotations to the streaming image at the appropriate locations in the streaming image are repeated, as indicated generally by step 616. In embodiments, one or more portions of the method 600 may not be needed to maintain the display of the color-based annotations on the streaming image by step 614. For example, after the nature of the color-based annotation is determined at step 608, the annotation generated by step 610 can be effectively resized as appropriate for changes to the scale of the FOV and added to the streaming image at step 612 without the need to reperform certain steps such as 608 of the method 600. However, as characteristics of the color-based ground feature change (e.g., the approach slope indicated by the PAPI system changes), the associated color-based annotation will be updated in accordance with the ground feature change.

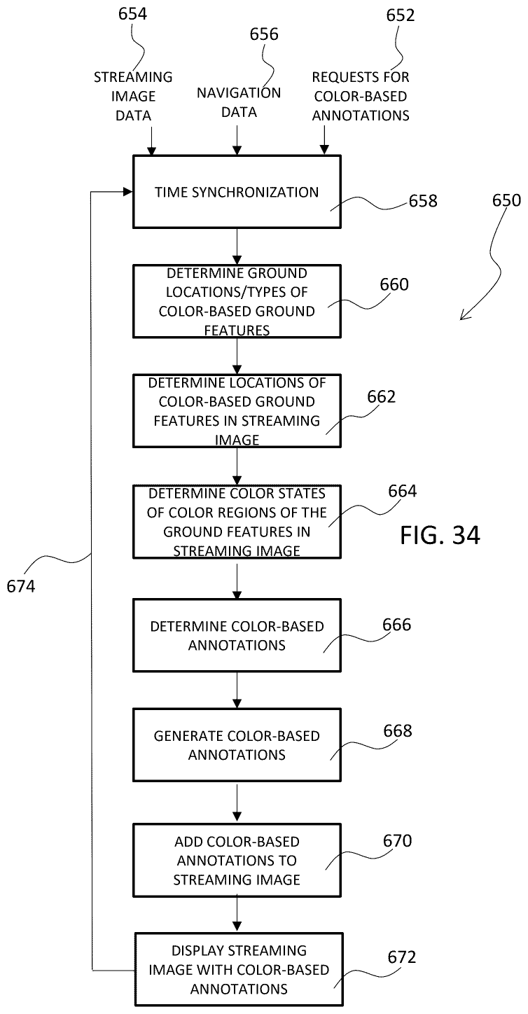

FIG. 34 is a diagrammatic illustration of a method 650 for generating an aircraft display including color-based ground feature overlays or annotations in accordance with embodiments. All or some of the steps of the method 650 can, for example, be performed by the avionics system 50 described in connection with FIG. 3 and its navigation and display system component and associated storage component 55 described in connection with FIG. 4. Alternatively or additionally, all or some of the steps of method 650 can be performed off the aircraft, for example by the computing system 36 and/or navigation information sources 38 (e.g., in the cloud), and the associated data and information communicated to and from the aircraft via the communication system 30. The following description of the method 650 includes exemplary references to the avionics system 50 and its components 53 and 55, and to the communication system 30, computing system 36 and navigation information sources 38.

As shown in FIG. 34, the method 650 receives as inputs the streaming images of a FOV from the aircraft 10 (step 654), and navigation information of the aircraft (step 656). Embodiments also receive one or more requests for color-based annotations (step 652) as an input. The streaming image information may, for example be received from one or more of the video cameras on the aircraft, such as the forward-facing camera 66 or the rearward-facing camera 68. The navigation information may, for example, be received from one or more of the GPS receiver 70 or the IMU 73.

Embodiments of the method 650 can be initiated in response to requests for color-based ground feature annotations to be overlaid or otherwise added onto the streaming images received by step 654. For example, the color-based ground feature annotation request can include one or more of (1) a request for one or more specific color-based ground features, such as for example PAPI systems or signal lights on towers, at particular airports, or (2) a general request to activate the color-based ground feature annotation capability of the avionics unit 52 (e.g., for all color-based ground features within the FOV of the streaming image). In embodiments, the color-based ground feature annotation request of step 652 is an audible or verbal request, for example received by the microphone 57 when the pilot speaks. Additionally or alternatively, the color-based ground feature annotation request may be received by user actuation of a user interface such as that provided by the control component 62 of display 58 (e.g., touch or gesture). In yet other embodiments, color-based feature annotation requests by step 652 can effectively be performed automatically. For example, the pilot may have stored configuration information that causes certain color-based ground feature annotations, such as for example airport light features within a predetermined distance and altitude (e.g., when the aircraft is on approach to a runway), to be received by step 652. The automatic receipt of color-based ground feature annotation requests by this approach can, for example be configured by a pilot-selected theme or other user customization stored in the user customizations 104 of the storage component 55.

Although not shown in FIG. 34, method 650 can process the color-based ground feature annotation requests received at step 652, if necessary or otherwise appropriate. For example, if the requests at step 652 are audible requests, the navigation and display system processing component 53 may perform natural language processing (NLP) on the audible requests to identify the request and/or or information elements such as any particular color-based ground features in the request. In embodiments, the NLP can include a multistep approach by first converting the audible speech that includes the request into text form, for example by speech recognition component 83, and then parsing the text form of the speech to identify the request and/or particular color-based ground features, for example by the information extraction component 85.

In other situations of the type described above, the request for color-based ground feature annotations may be more general, and may not include the identity of the requested ground feature or airport. For example, if the request for color-based annotations is for a “nearby” airport at a particular heading (e.g., in front of the aircraft), the location of the requested airport can be determined by accessing navigation information sources such as 38 or 106 based on the location of the aircraft 10.

At step 658, the streaming image information (from step 654) and the navigation information (from step 656) can be time synchronized, as needed or otherwise appropriate. For example, the streaming image information and navigation information may include time stamp information representative of the time that the information was captured or received. Accuracy of the information generated by the method 650, such as the positional locations of the color-based ground feature annotations on the displayed streaming image, can be enhanced by sufficiently time-synchronizing the information at step 658. The time synchronization by step 658 may, for example, be performed by the preprocessing component 81 of the navigation and display system processing component 53. In embodiments, the preprocessing component 81 may also perform other preprocessing of the streaming image information (from step 654) and the navigation information (from step 656), for example to format the information in manners that facilitate efficient processing during subsequent steps of the method 650.

At step 660, method 650 determines the locations (e.g., on the ground) and optionally the types (e.g., PAPI system, VASI system or tower signal light) of the color-based ground features that are to be annotated. In embodiments, at step 660 the method 650 determines the locations of the color-based ground features identified or otherwise requested by step 652. The locations of the color-based ground features can, for example, be the geo locations of the ground features. Locations of the color-based ground features can, for example be determined from NASR information stored by the navigation information sources 106 of the storage component 55 of avionics unit 52, or accessed from sources off the aircraft such as navigation information sources 38. In embodiments, the type of the color-based ground feature may also be determined from the navigation information sources 106 or 38, for example based on the locations of those ground features.

At step 662, method 650 determines the locations of the color-based ground features in the streaming image. In embodiments, the locations of the color-based ground features in the streaming image are determined at step 662 based on the ground locations of the ground features determined by step 660 and the location and orientation of the aircraft 10 represented by the navigation information received at step 656. In embodiments, vector processing, such as that performed for example by the vector component 84, can be performed by method 650 at step 662 to determine the locations of the ground features of interest in the streaming images.

As shown by step 664, method 650 determines the color states of the color-based ground features in the streaming image. In embodiments, step 664 is performed by determining the color states represented by the streaming image information in the portions (e.g., pixels) of the streaming image information that corresponds to the locations of the color-based ground features in the streaming images determined at step 662. For example, the streaming image information representing the locations of the color-based ground features may include information that corresponds to colors, such as for example red, green and white. Embodiments may also use artificial intelligence approaches such as trained deep neural networks and/or convolutional neural networks to locate the ground features in the streaming image data, for example with higher precision and/or to perform lighting state classification.

At step 666, method 650 determines the color-based annotation to be displayed for the color-based ground feature. Examples of the color-based annotations determined at step 666 can include, for example, the type of the color-based annotation and the color state of the color-based annotation. In embodiments, types of color-based annotations include symbol annotations such as the PAPI system symbol annotation 531 shown in FIG. 29 and the signal light symbol annotations 561 and 571 shown in FIGS. 31 and 32, respectively, including the color states of the symbol annotations. The determination of the color-based annotation at step 666 can be based upon the type of the color-based ground feature (e.g., PAPI system, VASI system or tower signal light) as determined by step 660 and/or upon the color states of the ground features as determined by step 664. Information defining the color-based annotation may be determined, for example, by accessing annotation feature maps 193 of the storage component 55. In embodiments, the annotation feature maps 193 include symbol maps that map each of one or more types of color-based ground features and associated color and/or temporal states to a corresponding symbol annotation having an associated color state (and characteristic representing a temporal state, if appropriate, in embodiments). As an example, symbol maps of these types can map a PAPI system such as 502 having the color states of lights 504, 506, 508 and 510 shown in FIG. 29 to the symbol annotation 531 also shown in that FIG. 29. As other examples, the symbol maps can map signal lights such as 562 and 577 having the color states described in connection with FIGS. 31 and 32 to the symbol annotations 561 and 571, respectively, also shown in those FIGS. 31 and 32.

At step 668, method 650 generates the color-based ground feature annotation. In embodiments, the color-based annotation can be generated based upon the information determined at step 666. In some embodiments, at step 668 the method 650 generates the color based ground feature annotation to have an appropriate size to correspond to the size or scale of the associated color-based ground feature determined at step 662.

At step 670, the color-based ground feature annotation generated by step 668 is added to the streaming image information at the appropriate location determined by step 662. The video information defining the streaming image with the color-based ground feature annotations is then displayed, for example by the image component 60 of the display 58, as shown by step 672.

Steps of the method 650 that are needed or otherwise appropriate to cause the color-based ground feature annotations to be displayed at step 672 as the streaming image is displayed in real time may be repeated. For example, if the aircraft 10 is in flight, the FOV of the streaming image will continuously change with the motion of the aircraft. Steps of the method 650 needed to continue to add the color-based ground feature annotations to the streaming image at the appropriate locations in the streaming image are repeated, as indicated generally by step 674. In embodiments, one or more portions of the method 650 may not be needed in maintain the display of the color-based ground feature annotations on the streaming image by step 674. For example, after the ground location and type of the color-based ground feature are determined by step 660, and the associated annotation is determined at step 666, the color-based ground feature annotation determined and generated by those steps may be effectively resized as appropriate for changes to the scale of the FOV, and added to the streaming image at step 672 without the need to reperform those steps. However, as characteristics such as the color states of the ground features change (e.g., the color of PAPI system lights change with changing glide slopes of the aircraft during landing), the associated color-based ground feature annotation will be updated accordingly.

Color-based ground feature annotations in accordance with the disclosed embodiments may offer important advantages. For example, they can use colorblind-friendly color pallets and/or symbols or other design patterns to enhance pilot's abilities to distinguish the colors and/or otherwise effectively perceive information conveyed by airport and other ground components such as VASI and PAPI system lights, rotating and other beacons, runway, taxiway and other lights, and air traffic control (ATC) or other tower signals. The color maps, symbol or other pattern maps and other annotation settings such as the types of color-based ground features to be annotated and situations where such annotations are requested or desired, can be selected by the pilots. They can therefore be tailored to the pilot's preferences and to optimize enhancement to their particular vision limitations. Use of this technology can enhance a pilot's ability to meet medical-related and practical requirements for licensing. The technology can also effectively enhance situational awareness for all pilots, not just those with color-based vision limitations.

One example of the color-based ground feature annotation embodiments is a method, for example performed by one or more processors. Steps of the method may comprise: receiving, from a camera on the aircraft, a streaming image from the aircraft; determining one or more color regions in the streaming image and a color state of each of the one or more color regions; generating a color-based annotation for each of the one or more color regions based upon the associated color state; generating a color-based annotated streaming image based upon the streaming image and including each color-based annotation, wherein each color-based annotation is at a location in the color-based annotated streaming image corresponding to a location of the associated color region; and displaying the color-based annotated streaming image in the aircraft.

In some embodiments of the method, determining the color state of the one or more color regions includes determining the color state from information representative of the streaming image produced by the camera. For example, determining the one or more color regions includes determining a location of the one or more the color regions from information representative of the streaming image produced by the camera. In some embodiments, for example, generating the color-based annotation includes: accessing a color map based upon the color state, wherein the color map includes color mapping information mapping each of one or more first color states to a corresponding second color state, and wherein the corresponding second color state is different than the first color state; and remapping the one or more color regions of each first color state to the associated second color state based upon the color mapping information. Some embodiments further comprise generating the color map based upon user input.

In any or all of the above embodiments, determining the one or more color regions includes determining a location of the one or more the color regions from information representative of the streaming image produced by the camera.

Any or all of the above embodiments may further comprises receiving navigation information representative of a location and orientation of the aircraft; receiving airport feature information associated with each of the one or more color-based airport features from a source of descriptive details of airport infrastructure; determining, based upon the navigation information and the airport feature information, a location of each of one or more color-based airport features with respect to the streaming image; and determining the color state of the one or more color regions in the streaming image includes determining a color state of each of the one or more color-based airport features. For example, generating the color-based annotated streaming image includes adding a symbol to the streaming image at a location associated with the associated color-based airport feature, wherein the symbol is representative of the color-based airport feature. In some embodiments, generating the color-based annotated streaming image includes generating a symbol having one or more colors different than the color state of the color-based feature.

In any or all of the above embodiments, generating the color-based annotation for each of the one or more color regions includes accessing a symbol map including symbol mapping information mapping each of the one or more color-based airport features to a symbol. For example, generating the color-based annotated streaming image for each of the one or more color regions includes adding a symbol from the symbol map to the color-based annotated streaming image. In some embodiments, accessing the symbol map includes accessing the symbol map based on a type of the color-based airport feature. In some embodiments, receiving airport feature information includes receiving the color-based airport feature information via the Federal Aviation Administration (FAA) National Airspace System Resource (NASR) and/or the FAA Airport Data Information Portal (ADIP).

In any or all of the above embodiments, receiving the image includes receiving a streaming image of a field of view in front of a cockpit of the aircraft. For example, displaying the color-based annotated image includes displaying a color-based annotated streaming image on a visual display in a cockpit of the aircraft.

Another example of the color-based ground feature annotation embodiments comprises a computer system including one or more processors, and memory storing instructions that when executed by the one or more processors causes the one or more processors to perform the steps of any of the embodiments of the method described above.

Yet another example of the color-based ground feature annotation embodiments comprises a non-transitory computer-readable medium storing instructions that, when executed by one or more processors of a computer system, causes the computer system to perform the steps of any of the embodiments of the method described above.

### Automated Display of Briefing Broadcast Information Embodiments

Automated display of briefing broadcast information embodiments provide visual or graphical, including text-based (e.g., readable) displays of information contained in automated briefing and other broadcasts received by aircraft, and that might otherwise be presented to pilots in audible form. Examples of broadcasts that can be displayed by these embodiments include Automatic Terminal Information Service (ATIS), Automated Weather Observing System (AWOS), Automated Surface Observing System (ASOS), Notice to Air Missions (NOTAM), Significant Meteorological Information (SIGMET) and Airman's Meteorological Information (AIRMET). Systems such as those described generally with reference to FIGS. 2-4 can be configured to provide these automated display of briefing broadcast information embodiments, for example in aircraft 10 operating in environments such as 8 described with reference to FIG. 1.

In embodiments, as an aircraft is starting or is about to enter an airspace where a briefing broadcast is available, the system will automatically “listen” to the broadcast and display relevant information in the broadcast to the pilot, for example on a touchscreen or other display in the cockpit such as the control component 62 of display 58. Embodiments of the broadcast displays can emphasize certain information such as NOTAMs and special remarks for the local airspace and/or airports.

In embodiments, the briefing broadcast displays provided by the system are activated or initiated by one or more modes. One example of such a mode includes a pilot's selection of a specific airport (e.g. from a list of nearby airports that may be presented on the control component 62 of the display 58). Another example of a mode is a “free scan mode,” where the system automatically gathers briefing data or information from a plurality of airports, such as for example those that are within a specified distance of the aircraft 10, and displays a suggestion for one of those airports for landing, for example a best airport, based on the information in the briefing information. As yet another example of such a mode, the system can be voice activated, for example by a tasking a personal-assistant-like system via microphone 57 to “check Duluth ATIS for newest weather conditions.” Embodiments can be configured present relevant information determined from the broadcasts, such as a particular airport's approach contact or other communication frequency (e.g., COM1) and/or altimeter value, on a control component 62 of the display 58 (e.g., after the system has received and parsed the necessary information from a broadcast). The pilot can then actuate the control component 62 to send the associated information values to the appropriate component of the avionics system 50.

Avionics system 50 can be configured to provide the briefing broadcast displays using Deep Neural Network (DNN) technologies for Automatic Speech Recognition (ASR) and Information Extraction (IE), for example by the speech recognition component 83 and associated speech recognition model 101 and information extraction component 85 and associated information extraction model 102. Audio from the very high frequency (VHF) or other radios 56 can be input to a DNN capable computer of the avionics system 50. The system can tune the VHF radio to a specific frequency, based on the mode it is operating in, by communicating with the aircraft avionics. The audio can then be inputted into an ASR model onboard the DNN computer, giving a full transcript of the audio broadcast (which can also be presented in audible form to the pilot, for example by speaker 59). The transcript or text-based form of the broadcast can then be fed into the IE model, which extracts the relevant information elements such as specific weather elements and remarks. After the information elements are extracted, they can be converted to corresponding values (e.g., numbers) if appropriate, and are presented on the display 58.

In embodiments, the ASR model implemented by the speech recognition model 101 is trained on audio from real-world examples of automated briefing broadcasts. Similarly, embodiments of the IE model implemented by the information extraction model 102 can be trained on transcriptions of automated briefing broadcasts that have been annotated with the identified and associated information elements. Using dynamic word-boosting by reference location for specific words that might be expected to occur in the briefing broadcasts, the ASR model may provide a better overall accuracy for the final text-based transcript. Words that may be more relevant to the current scenario and location of the aircraft may be used as part of a dynamic ‘word-boosting’ algorithm for ASR. This approach can, for example be implemented in the avionics system 50 to enable the aircraft's location to be used to reference a database such as those of the navigation information sources 38 and or 106 for navigational waypoints, airports, landmarks, and other relevant information element values such as phrases that may appear in a broadcast. By this approach the ASR model may be optimized to recognize these words.

After they are identified, the individual information elements are populated into or added to, and displayed by the display 58. Examples of information elements that can be identified in and extracted from the briefing or other broadcasts, and presented on the display 58, include but are not limited to the airport or location, phonetic letter code or name, time, wind speed, wind direction, gust speeds, cloud layers, temperature, dew point, altimeter, density altitude, active runway, relevant NOTAMs and/or remarks for an airport/briefing station. In embodiments, the displayed information elements can be any smaller subset of those listed as examples above, as not all airports may broadcast all of the listed information elements. Additional or alternative examples of information elements that may be identified, extracted and displayed include those relating to the presence of high crosswinds or high wind gusts above some threshold that may be the subject of a special notification. In embodiments, information elements of these types, and/or other information elements, can be highlighted on the display 58. For example, the same or a similar type or style of information element display can be used for information elements such as notifications for dangerous or conditions that may warrant caution for any of the other elements, such as: instrument flight rule (IFR) conditions, low visibility, poor runway conditions, wind shear warnings, SIGMET, AIRMET, closed taxiways/aprons, parallel runways in use, active runways in use, hold short and readback instructions, high cross winds, icing conditions, de-ice pads closed, etc.

In embodiments, at least some of the displayed information elements are presented on a user-actuatable user interface, such as for example the control component 62 of the display 58. The pilot can then actuate the associated control component, and cause the avionics unit 52 to be controlled by or otherwise take action based upon the associated information element or its value. For example, comms frequencies extracted from briefing broadcasts can be populated to an actuatable display field that can be used to switch comms frequencies. In response to user actuation of the associated portion of the display, the avionics unit 52 can switch appropriate components such as one or more radios 56 to operate at the displayed comms frequencies. As an example, in an ATIS where the operator states “contact approach on [frequency],” the avionics unit 52 can be automatically configured in such a manner that the radios 56 will switch to the stated frequency when the pilot actuates the user interface associated with the displayed frequency (e.g., presses a button the control component 62 of display 58). As another example, an airport's altitude can be displayed in an actuatable display field of the control component 62 of display 58. When the user interface associated with the displayed altitude is actuated by the pilot, the avionics unit 52 can automatically fill or incorporate that altitude value and use that value.

When aircraft 10 is in flight, embodiments of avionics system 50 can automatically use the GPS location of the aircraft to reference nearby airports, and to find associated comms frequencies to tune the VHF or other radios 56 to. The avionics system 50 may review or audit all nearby airports (e.g., within a predetermined distance of the aircraft 10) to determine a best or most appropriate airport for landing, or it may display identifiers of all or some (e.g., the nearest) of the identified airports, on the user-actuatable portions such as control components 62 of the display 58. The pilot can actuate the user interface to select the desired airport to obtain the associated briefing broadcasts, and/or to have the information elements from those briefing broadcasts displayed by the automated briefing broadcast display functionality described herein. In embodiments, avionics system 50 can be voice activated, for example using a personal assistant mechanism onboard the aircraft 10. Embodiments of the automated briefing broadcast display functionality can also automatically identify in briefing broadcasts potentially hazardous conditions (e.g., associated with an airport), and provide a display suggesting alternatives, such as for example an alternative airport if that airport is within range and has better conditions.

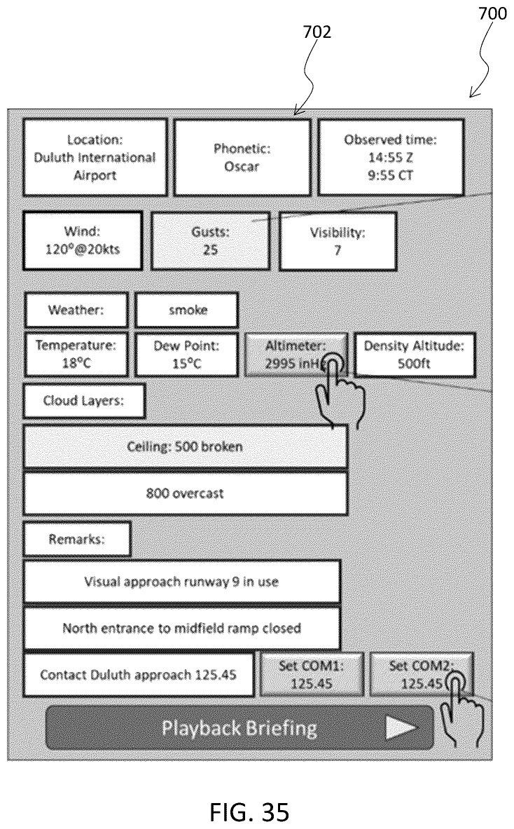

FIG. 35 is a diagrammatic illustration of an exemplary briefing broadcast display 700 that can be produced by the avionics system 50 in accordance with embodiments. The briefing broadcast display 700 can, for example, be presented or displayed by the image component 60 and/or control component 62 of the display 58. As shown, the display 700 includes plurality of graphical information element fields 702, each of which includes an information element in text form, and that may have an associated numerical value. In the illustrated embodiments, the display 700 also includes a descriptor of the associated information element in text form for each of one or more of the information elements. Additionally or alternatively, the display 700 can include graphical (e.g., symbol) versions of descriptors. In the example display 700, the information element fields 702 include: a location field displaying the “Location” descriptor and “Duluth International Airport” as an information element; a phonetic field displaying the “Phonetic” descriptor or letter code and “Oscar” as an information element; a time field displaying the “Observed Time” descriptor and “14:55 Z” and “9:55 CT” as information elements; a wind direction and speed field displaying the “Wind” descriptor and “120°@ 20 kts” as information elements; a wind gusts field displaying the “Gusts” descriptor and “25” as an information element; a visibility field displaying the “Visibility” descriptor and “7” as an information element; a weather field displaying the “Weather” descriptor and “smoke” as an information element; a temperature field displaying the “Temperature” descriptor and “18° C.” as an information element; a dew point field displaying a “Dew Point” descriptor and “15° C.” as an information element; an altitude field displaying an “Altimeter” descriptor and “2995 in Hg” as an information element; an air density altitude correction field displaying a “Density Altitude” descriptor and “500 ft” as an information element; a cloud information field displaying “Cloud Layers” and “Ceiling” descriptors and “500 broken” and “800 overcast” as information elements; an other information field displaying a “Remarks” descriptor and “Visual approach runway 9 in use,” “North entrance to midfield ramp closed,” and “Contact Duluth approach 125.45” as information elements; a first radio frequency comms setting information field displaying a “Set COM 1” descriptor and “125.45” as an information element; and a second radio frequency comms setting information field displaying a “Set COM 2” descriptor and “125.45” as an information element. Other embodiments (not shown) include additional and/or different information element fields, and/or one or more information element fields that do not include a descriptor (e.g., the nature of the information element may be apparent to the pilot).

As noted above, one or more of the information element fields 702 can be configured as user-actuatable fields. In the embodiments of the briefing broadcast display 700 shown in FIG. 35, the air density altitude correction field, first radio frequency comms setting information field and second radio frequency comms setting information field are configured as user-actuatable fields, for example by the control component 62 of the display 58. By actuating the air density altitude correction field labeled with the descriptor “Altimeter” (e.g., by touching the displayed information field), the pilot can cause the avionics unit 52 to use the value of the displayed information element, “2995 in Hg” in this example, to adjust altimeter setting parameters determined by the avionics unit. By actuating the first radio frequency comms setting information field labeled with the descriptor “Set Com 1,” the pilot can cause the avionics unit 52 to set a first of the radios 56 for operation and communication at the frequency value of the displayed information element, “125.45” in this example. Similarly, by actuating the second radio frequency comms setting information field labeled with the descriptor “Set Com 2,” the pilot can cause the avionics unit 52 to set a second of the radios 56 for operation and communication at the frequency value of the displayed information element, “125.45” in this example. Other embodiments (not shown) include additional and/or alternative user-actuatable information element fields.

Embodiments of the avionics system 50 incorporating the automated briefing or other broadcast display functionality may store a copy of the audible version of the broadcast from which the displayed information elements were identified and extracted. The audible version of the briefing broadcast can, for example be stored by the storage component 55 of the avionics unit 52. In the embodiments where the audio version of the broadcast is stored, a user-actuatable element can be presented to the pilot to enable an audible playback of the stored broadcast. The briefing broadcast display 700 shown in FIG. 35, for example, includes a user-actuatable element labeled with a descriptor “Playback Briefing” that can be actuated by the pilot to cause the audible presentation (e.g., by speakers 59) of the stored briefing broadcast. In some embodiments, the avionics system 50 can update one or more of the information element fields 702 in the display 700 when the briefing broadcast is played back.

One or more of the information element fields are highlighted in embodiments, for example to enhance the likelihood that the pilot will see the information element and/or to more quickly direct the pilot's attention to the information element field. For example, if the information element value of an information element field represents a possibly hazardous or otherwise out of the ordinary situation, the information element field can be highlighted. Information element values can, for example, be compared to threshold values to determine if they should be highlighted. In the briefing broadcast display 700, the wind gusts information field is highlighted to indicate that the wind gusts are relatively high, and the cloud information field is highlighted to indicate the relatively low cloud ceiling. Alternatively and/or additionally, information elements that may be highlighted include certain IFR conditions, low visibility, poor runway conditions, wind shear warnings, SIGMET, AIRMET, closed taxiways/aprons, parallel/active runways, hold short and readback instructions, high cross winds, and/or icing conditions.

In embodiments, the information field elements 702 are organized and laid out or otherwise formatted so as to be displayed at predetermined locations on the display 58, for example to optimize the effectiveness by which the information is provided to the pilots (e.g., so that the pilot can generally expect to see particular information element fields at the same or similar locations in the display). In the briefing broadcast display 700 shown in FIG. 35, for example, the information element field that identifies the airport or other location at which the information in the briefing broadcast is associated is displayed at a relatively prominent location at the top of the display. Weather-related fields including the wind direction and speed field, wind gusts field, visibility field and cloud information field are organized and displayed as a group. Relevant airport altitude-related fields such as the altitude field and air density altitude correction field are organized and displayed as a group. Certain navigation-related information, such as for example those in the other information field, are organized and displayed as a group. Similarly, comms-related information including the first and second radio frequency comms setting information fields are organized and displayed as a group.

In embodiments, the avionics unit 52 can store display data structures, such as for example in the storage component 55, that define templates for the organization and layout formats of the information element fields 702. In addition to defining the organization and layout of the information element fields 702, the display data structures in some embodiments also include other information relating to the displays of the information element fields, such as for example the associated descriptors. Embodiments of the avionics system 50 may enable the pilot to select one of the stored templates, and/or to customize or create their own templates. The avionics unit 52 may populate the information element fields 702 of the display data structure or template with the associated information elements. Information element fields that do not have associated information element values (e.g., when the briefing broadcast did not include the information element values) can have the information element left blank, or the information element field can be deleted so as to be not displayed.

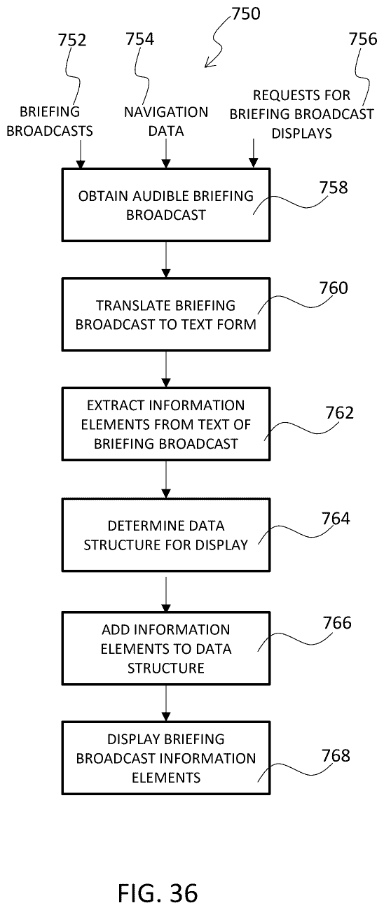

FIG. 36 is a diagrammatic illustration of a method 750 for generating a display of briefing and other broadcast information elements in accordance with embodiments. As described below, all or some of the steps of the method 750 can be performed by the avionics system 50 described in connection with FIG. 3 and its navigation and display system processing component 53 and associated storage component 55 described in connection with FIG. 4.

Alternatively and/or additionally, all or some of the steps of method 750 can be performed using components off the aircraft, for example by the computing system 36 and/or navigation information sources 38 (e.g., in the cloud), with the associated data or information being communicated to and from the aircraft via the communication system 30. The following description of the method 750 includes exemplary references to the avionics system 50 and its components 53 and 55, and to the communication system 30, computing system 36 and navigation information sources 38.

As shown in FIG. 36, the method 750 receives as an input broadcasts (step 752). Embodiments also receive one or more of navigation information from the aircraft (step 754) and requests for briefing broadcast displays (step 756) as inputs. The broadcasts may, for example, be one or more of the ATIS, AWOS, ASOS, NOTAM, SIGMET or AIRMET briefing broadcasts. These broadcasts can be received, for example, at step 752 by the radios 56 of the aircraft 10.

Embodiments of the method 750 can be initiated in response to the requests for the display of information elements in the briefing broadcasts by step 756. For example, the briefing broadcast display request can include one or more of (1) a request for the display of one or more specific briefing broadcasts, such as an ATIS broadcast, from a particular airport, (2) a request for the display of one or more specific broadcasts, such as an ATIS broadcast, from nearby airports such as those within a predetermined distance of the aircraft 10, or (3) a general request to activate the briefing broadcast display capability of the avionics unit 52. In embodiments, the briefing broadcast display request of step 756 is an audible or verbal request, for example received by the microphone 57 when the pilot speaks. Additionally or alternatively, the briefing broadcast display request may be received by user actuation of a user interface such as that provided by the control component 62 of display 58 (e.g., touch or gesture). Yet other briefing broadcast display requests by step 756 can effectively be performed automatically. For example, the pilot may have stored configuration information that causes certain briefing broadcasts, such as for example, ATIS broadcasts from airports within a predetermined distance, or broadcasts that are otherwise being audibly presented to the pilot (e.g., by speaker 59) based on other actions the pilot has taken such as having selected the comms frequency for the airport, to be received by step 756. The automatic receipt of briefing broadcast display requests by this approach can, for example, be configured by a pilot-selected theme or other user customization stored in the user customizations 104 of the storage component 55.

Although not shown in FIG. 36, method 750 can process the briefing broadcast requests received at step 756, if necessary or otherwise appropriate. For example, if the requests at step 756 are audible requests, the navigation system and display processing component 53 may perform natural language processing (NLP) on the audible requests to identify the request and/or other relevant aspects of the request such as the airport or the type of requested briefing broadcast. In embodiments, the NLP can include a multistep approach by first converting the audible speech that includes the request into text form, for example by speech recognition processing component 83, and then parsing the text form of the speech to identify the request and/or the other relevant aspects, for example by the information extraction processing component 85.

In other situations of the type described above, the briefing broadcast requests may be more general, and may not include the identity of an airport. For example, if the request for the briefing broadcast display is for a “nearby” airport at a particular heading (e.g., in front of the aircraft), the location of the requested airport can be determined by accessing navigation information sources such as 38 or 106 based on the location of the aircraft 10.

At step 758, the method 750 obtains the requested briefing broadcast. For example, the frequency at which the requested briefing broadcast is transmitted can be obtained from navigation information sources such as 38 or 106, such as for example NASR information, based upon the knowledge of the airport or other source. The avionics system 50 can then tune the radios 56 to that frequency, to cause the receipt of the requested briefing broadcast by step 758. Although not shown in FIG. 36, in some embodiments the briefing broadcasts received at step 758 are stored and/or simultaneously presented to the pilot in audible form.

At step 760, method 750 processes the audio briefing broadcast to convert or translate the briefing broadcast into corresponding text form or data. In embodiments, the navigation and display system processing component 53 can perform NLP on the audible briefing broadcasts at step 760. For example, the briefing broadcast can be processed by the speech recognition component 83 to convert the briefing broadcast into text form. In embodiments, the speech recognition component 83 is a trained model, and uses the speech recognition model 101 in connection with step 760.

At step 762, method 750 processes the text form of briefing broadcast to extract or otherwise determine the relevant information elements contained in the briefing broadcast. For example, the text for of the briefing broadcast can be processed by the information extraction component 85 to determine the information elements. In embodiments, the information extraction component 85 is a trained model, and uses the information extraction model 102 in connection with step 762.

At step 764, method 750 determines a data structure defining the format, such as for example the organization and layout, of the display. In embodiments, for example, the data structure may include one or more descriptors of information elements that may be included in the display, the positions of information element fields in the display, the nature of the fields, such as for example if the information element is to be presented in a user-actuatable information element field. In embodiments, the data structures determined at step 764 can be obtained as stored templates, for example from the storage component 55.

At step 766, method 750 effectively generates the data structure defining the display of the information elements in the briefing broadcast. In embodiments, for example, the information elements determined at step 762 can be added to the appropriate locations, such as the associated information element fields that may include associated descriptors, of the data structure determined by step 766. In addition to populating the data structure with the information elements, other actions can be taken to place the data structure in an appropriate form for display. For example, if the data structure includes information element fields for information elements that were not present in the briefing broadcast, those information element fields can be deleted, rather than leaving them blank, to enhance the visual appearance and information display effectiveness of the associated display. As another example, certain information element fields may be structured to be presented in highlighted form.

At step 768, the information elements from the briefing broadcast are displayed, for example on the display 58. Following the examples above, the data structure generated in accordance with step 766 and populated with the information elements from the briefing broadcast can be used as the basis for the information element display.

Briefing broadcast information element displays in accordance with the disclosed embodiments can provide important advantages. For example, before flight, and possibly before taxiing of a general aviation aircraft, a pilot will often tune a radio comm channel into the VHF broadcast of an automated audible briefing broadcast such as ATIS for important information for the flight. The pilot may then take time to write down certain relevant information obtained from the briefing broadcast, during which the plane may be consuming fuel. Similarly, when approaching an airspace, a pilot will typically tune a radio comm channel to an automated briefing, and write down the relevant weather, airport and other information obtained from the briefing. When recording this information, a pilot's attention may be drawn away from their surroundings. This action may present a safety risk if in a busy airspace. While listening to a briefing broadcast while in flight, the pilot will typically also have a radio tuned into the control frequency of an airspace, and if this airspace is busy there may be several communications occurring during a short period of time. Situations such as these may increase demands on the pilot, and may make it more difficult for the pilot to listen to the briefing broadcast and record the relevant information.

A benefit of the automated briefing broadcast information display embodiments is that it may reduce the demands on the pilot. For example, the pilot's attention may not be required to obtain relevant information. These embodiments automatically obtain the relevant information and present it to the pilot in a form by which the pilot can efficiently and effectively assess that information (e.g., when there are not other possibly more important demands for their attention). The pilot can simply reference the visual display for the relevant information elements, at a time of their choosing. Another benefit, perhaps especially in a busy airspace, is that the pilot may not have to listen to the briefing broadcast multiple times. Information provided by these embodiments can be used by avionics systems to prepopulate fields such as channel frequency to switch to for contact, and altimeter settings, thereby reducing chances of data entry errors. In general, these embodiments can increase operational efficiency by extracting information for ease of use and automation in the cockpit.

One example of the automated briefing broadcast information display embodiments is a method, for example performed by one or more processors. Steps of the method may comprise: receiving an audible aviation broadcast; translating the broadcast into text data; extracting one or more information elements from the text data; and displaying the one or more information elements in graphical form on a visual display in the aircraft.

In some embodiments of the method, the audible aviation broadcast includes one or more of an Automatic Terminal Information Service (ATIS) broadcast, Automated Weather Observing System (AWOS) broadcast, Automated Surface Observing System (ASOS) broadcast, Notice to Air Missions (NOTAM) broadcast, Significant Meteorological Information (SIGMET) and Airman's Meteorological Information (AIRMET) broadcast.

In any or all of the above embodiments, displaying the one or more information elements includes displaying the information elements in text form.

In any or all of the above embodiments, the method further comprises displaying an associated descriptor of the one or more information elements. The descriptor can, for example, be in text form and/or a symbol.

In any or all of the above embodiments, displaying the one or more information elements includes displaying each of the information elements at a predetermined location on the visual display.

In any or all of the above embodiments, the method further comprises providing a display including a plurality of information descriptors at predetermined layout locations; and displaying the one or more information elements includes displaying a plurality of the information elements, wherein each of the plurality of information elements is displayed adjacent to an associated one of the plurality of information descriptors.

In any or all of the above embodiments, the method further comprises highlighting one or more of the one or more displayed information elements. For example, highlighting the one or more displayed information elements can include highlighting one or more displayed information elements that reflect an out of the ordinary or possibly hazardous condition.

In any or all of the above embodiments, displaying the information elements includes displaying one or more of the information elements on a user-actuatable user interface. For example, displaying the one or more information elements on a user-actuatable user interface includes displaying one or more of an airport altitude or an airport communication frequency on the user-actuatable user interface. In some embodiments, the method further comprises receiving a signal representing user actuation of the user-actuatable user interface associated with an information element; and storing, in avionics of the aircraft, information associated with a value of the information element of the actuated user-actuatable user interface (e.g., so that the avionics can use the value in connection with actions taken such as tuning a radio or setting an altimeter).

In any or all of the above embodiments, the method further comprises receiving a request for an audible aviation broadcast for a specific airport, optionally via a voice request or user actuation of a graphical user interface; and receiving the audible aviation broadcast includes receiving the audible aviation broadcast for the requested airport.

In any or all of the above embodiments, the method further comprises displaying a list of airports near the aircraft. For example, displaying the list of airports includes displaying the list of airports on a user-actuatable user interface enabling a user to select one of the airports; and in response to the user selection of one of the airports, one or more information elements from an aviation broadcast associated with the selected airport are displayed in accordance with the embodiments described above.

In any or all of the above embodiments, translating the aviation broadcast into text form includes translating the aviation broadcast using speech recognition software. For example, the speech recognition software can include a model trained using aviation terminology.

In any or all of the above embodiments, extracting the information elements includes extracting the pilot information elements using information extraction software. For example, the information extraction software can include a model trained using aviation terminology.

Another example of the automated display of briefing broadcast information elements embodiments comprises a computer system including one or more processors, and memory storing instructions that when executed by the one or more processors causes the one or more processors to perform the steps of any of the embodiments of the method described above.

Yet another example of the automated display of briefing broadcast information elements comprises a non-transitory computer-readable medium storing instructions that, when executed by one or more processors of a computer system, causes the computer system to perform the steps of any of the embodiments of the method described above.

### Exemplary Computer System

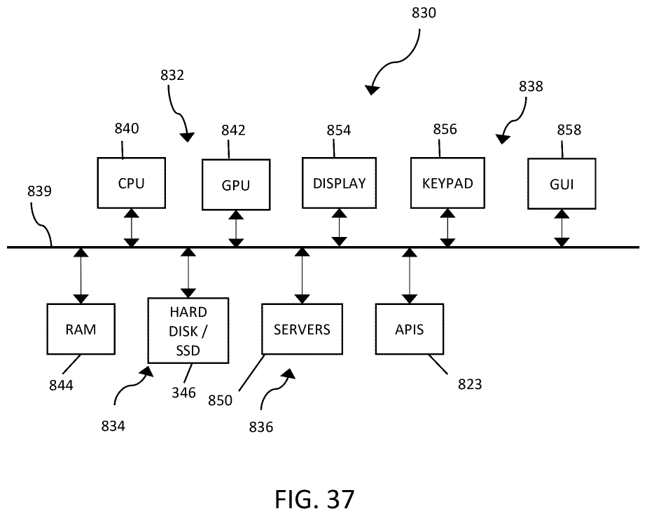

FIG. 37 is a diagrammatic illustration of an exemplary computer system 830 that may be used to implement one or more of components of the computing system 36 and/or avionics system 50 in accordance with some embodiments to provide the navigation system and displays described herein. The illustrated embodiments of computer system 830 include processing components 832, storage components 834, network interface components 836, and user interface components 838 coupled by a system network or bus 839.

Processing components 832 may, for example, include a central processing unit (CPU) 840 and a graphics processing unit (GPU) 842, and provide the processing functionality of the computer systems. The storage components 834 may include RAM memory 844 and hard disk/SSD memory 846, and provide the storage functionality of the computer systems.

For example, operating system software used by the processing components 832 and one or more applications or apps used to implement methods described herein may be stored by the storage component 834. By way of example, software executed by the computing system 36 and/or the avionics unit 52, and/or software executed to provide the functionalities (e.g., method steps) of the avionics and navigation system displays as described herein, may be stored by the storage components 834.

In some embodiments, the network interface components 836 may include one or more web servers 850 and one or more application programming interfaces (APIs) 852 to implement interfaces between the components of the communication system 30 and the avionics system 50. Examples of user interface components 838 may include display 854, keypad 556, and graphical user interface (GUI) 858 (which can for example be used to implement the display 58). Some embodiments of computer system 830 may include other conventional or otherwise known components to provide the navigation and display processing methods described herein.

Speech recognition model 101 and information extraction model 102 can, in some embodiments, be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

According to certain embodiments, machine learning programs may be trained by inputting sample data sets or certain data into the programs, such as images take from aircraft, including images of airports and ground features, object statistics and information, aviation comms and aviation briefing broadcasts. As noted above, the models can be enhanced by using training data sets including aviation-related terminology. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

### Additional Considerations

The inventions disclosed in this application have been described above both generically and with reference to specific embodiments. It will be apparent to those skilled in the art that various modifications and variations can be made in the embodiments without departing from the spirit and scope of the disclosure. Thus, it is intended that the embodiments cover the modifications and variations of this invention provided they come withing the scope of the appended claims and their equivalents.

Although various features of the disclosure that are, for brevity for example, described in the context of a single embodiment, they may also be provided separately or in any sub-combination. For example, although the image display with navigation information annotations embodiments, image display with surrounding aircraft information annotation embodiments, image display with ground feature color information annotation embodiments, and automated display of briefing broadcast information elements embodiments are described separately, one or more, or all, of the features of any of these embodiments can be combined with one or more, or all of the features of any one or more of the other embodiments. Although the methods described for implementation of these different embodiments include reference to specific steps, other embodiments can include additional and/or alternative steps. Furthermore, unless expressly required, steps can be omitted, and/or performed in in different orders than described and shown in the drawings.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and may be implemented in a high-level procedural and/or object-oriented programming language, and/or in assembly/machine language. As used herein, terms such as “machine-readable medium” and “computer-readable medium” and the like refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” and the like refers to any signal used to provide machine instructions and/or data or information to a programmable processor.

As described herein, a processor may include any programmable system including systems using micro-controllers, reduced instruction set circuits (RISC), application specific integrated circuits (ASICs), logic circuits, and any other circuit or processor capable of executing the functions described herein. The above examples are examples only, and are thus not intended to limit in any way the definition and/or meaning of the term processor.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are examples only, and are thus not limiting as to the types of memory usable for storage of a computer program.

In embodiments, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

It should also be understood that, unless a term is expressly defined in this patent using the sentence “As used herein, the term ‘ ’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations or steps, one or more of the individual operations or steps may be performed concurrently, and nothing requires that the operations or steps be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more modules or components of a computer system (e.g., a processor or a group of processors) may be configured by software (e.g., an application or application portion) as a module that operates to perform certain operations as described herein.

Methods or routines described herein may be at least partially processor-implemented. For example, at least some of the operations of a method may be performed by one or more processors or processor-implemented modules or components. The performance of certain of the operations of components may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

What is claimed is:

1. A method for providing a display on an aircraft, comprising:
receiving, from a camera on the aircraft, a streaming image from the aircraft;
receiving navigation information representative of the location and orientation of the aircraft;
receiving surrounding aircraft information associated with each of one or more surrounding aircraft;
determining, based upon the navigation information and the surrounding aircraft information, a location of each of the one or more surrounding aircraft with respect to the streaming image;
generating a surrounding aircraft identifier for each of the one or more surrounding aircraft;
generating a surrounding aircraft-annotated streaming image based upon the streaming image and including each surrounding aircraft identifier, wherein each surrounding aircraft identifier is at a location in the surrounding aircraft-annotated streaming image corresponding to the location of the associated surrounding aircraft; and
displaying the surrounding aircraft-annotated streaming image in the aircraft.

2. The method of claim 1, wherein the surrounding aircraft information includes one or more of (1) information received from the surrounding aircraft, optionally Automatic Dependent Surveillance—Broadcast (ADS-B) information, (2) communication information from the surrounding aircraft, (3) information generated by a sensor on the aircraft, optionally radar information, or (4) information received from a ground-based source, optionally Air Traffic Control (ATC) information.

3. The method of claim 1, wherein:
the method further comprises determining, based upon the surrounding aircraft information, one or more aircraft characteristics relating to one or more characteristic-associated aircraft of the one or more surrounding aircraft, wherein the one or more aircraft characteristics includes one or more aircraft characteristics from a group including ground traffic, air traffic, audio, or track; and
generating the surrounding aircraft identifier for each of the one or more characteristic-associated aircraft includes generating a surrounding aircraft identifier representative of the determined aircraft characteristic.

4. The method of claim 3, wherein:
receiving the surrounding aircraft information includes receiving, and presenting in the aircraft concurrently with the receipt, audio information relating to each of one or more audio-associated aircraft of the surrounding aircraft determined to have an audio characteristic, wherein the audio information optionally includes one or more of communication information from the surrounding aircraft or Air Traffic Control (ATC) information;
generating the surrounding aircraft identifier for each audio-associated aircraft includes generating an audio surrounding aircraft identifier representative of the audio characteristic; and
displaying the surrounding aircraft identifier for each audio-associated aircraft includes displaying the associated audio surrounding aircraft identifier concurrently with the presentation of the associated audio information.

5. The method of claim 4, wherein generating the surrounding aircraft identifier for each audio-associated aircraft includes generating a highlighted surrounding aircraft identifier during the presentation of the associated audio information.

6. The method of claim 3, wherein:
receiving the surrounding aircraft information includes receiving track information relating to a vector of motion for each of one or more track-associated aircraft of the surrounding aircraft determined to have a track characteristic;
generating the surrounding aircraft identifier for each track-associated aircraft includes generating a track surrounding aircraft identifier representative of the vector of motion of the aircraft; and
displaying the surrounding aircraft identifier for each track-associated aircraft includes displaying the associated track surrounding aircraft identifier.

7. The method of claim 3, wherein:
receiving the surrounding aircraft information includes receiving ground traffic information for each of one or more ground traffic-associated aircraft of the surrounding aircraft determined to have a ground traffic characteristic;
generating the surrounding aircraft identifier for each ground traffic-associated aircraft includes generating a ground traffic surrounding aircraft identifier representative of the ground characteristic of the aircraft; and
displaying the surrounding aircraft identifier for each ground traffic-associated aircraft includes displaying the associated ground traffic surrounding aircraft identifier.

8. The method of claim 3, wherein:
receiving the surrounding aircraft information includes receiving air traffic information for each of one or more air traffic-associated aircraft of the surrounding aircraft determined to have an air traffic characteristic;
generating the surrounding aircraft identifier for each air traffic-associated aircraft includes generating an air traffic surrounding aircraft identifier representative of the air traffic characteristic of the aircraft; and
displaying the surrounding aircraft identifier for each air traffic-associated aircraft includes displaying the associated air traffic surrounding aircraft identifier.

9. The method of claim 1, wherein:
the method further comprises determining, based upon the navigation information and the surrounding aircraft information, a limited set of surrounding aircraft for identification; and
displaying the surrounding aircraft identifier includes displaying the surrounding aircraft identifier for only the surrounding aircraft in the limited set of surrounding aircraft.

10. The method of claim 9, wherein determining the limited set of surrounding aircraft for identification includes determining the limited set of aircraft based upon one or both of a maximum number of surrounding aircraft or a distance of the surrounding aircraft from the aircraft.

11. The method of claim 1, wherein:
determining the location of each of the one or more surrounding aircraft includes determining that one or more of the surrounding aircraft is outside a field of view of the streaming image; and
generating the surrounding aircraft-annotated streaming image includes generating the surrounding aircraft-annotated streaming image including the surrounding aircraft identifier for each of the one or more surrounding aircraft outside the field of view of the streaming image at a location in the surrounding aircraft-annotated streaming image, optionally a side of the surrounding aircraft-annotated streaming image.

12. The method of claim 1, wherein:
determining the location of each of the one or more surrounding aircraft includes determining that at least one of the surrounding aircraft is within a field of view of the streaming image; and
generating the surrounding aircraft-annotated streaming image includes generating the surrounding aircraft-annotated streaming image including the surrounding aircraft identifier for each of the at least one surrounding aircraft within the field of view at the location of the associated surrounding aircraft in the surrounding aircraft-annotated streaming image.

13. The method of claim 1 wherein the surrounding aircraft identifier includes one or more of (1) aircraft call sign, (2) a feature circumscribing all or part of the aircraft, (3) a feature defining aircraft intention, (4) a feature defining a track or direction, (5) aircraft velocity, (6) a feature indicating an on-ground nature, (7) a feature indicating an in-flight nature, (8) a feature indicating that the aircraft is engaged in audio communications, (9) a text box including aircraft intention, (10) relative altitude between the ownship aircraft and traffic, or (11) distance to the traffic.

14. The method of claim 1, wherein the method further comprises:
generating, based upon the streaming image, a zoomed-in streaming image of a portion of the streaming image including one or more of the surrounding aircraft;
generating a surrounding aircraft-annotated zoomed-in streaming image including each surrounding aircraft within a field of view of the surrounding aircraft-annotated zoomed-in streaming image at a location in the surrounding aircraft-annotated zoomed-in streaming image corresponding to a location of the associated surrounding aircraft; and
displaying the surrounding aircraft-annotated zoomed-in streaming image.

15. The method of claim 13, wherein displaying the surrounding aircraft-annotated zoomed-in streaming image includes displaying the surrounding aircraft-annotated zoomed-in streaming image as a picture in picture in the displayed surrounding aircraft-annotated streaming image.

16. The method of claim 1, wherein receiving the navigation information includes receiving the navigation information from one or both of a GPS receiver or an IMU on the aircraft.

17. The method of claim 1, wherein receiving the streaming image includes receiving a streaming image of a field of view in front of a cockpit of the aircraft.

18. The method of claim 17, wherein receiving the streaming image includes receiving the streaming image includes receiving a streaming image from one or more of out the back of the aircraft (e.g., from 6:00), from the left wing of the aircraft (e.g., from 9:00) or from the right wing of the aircraft (e.g., from 3:00).

19. The method of claim 17, wherein displaying the surrounding aircraft-annotated streaming image includes displaying the surrounding aircraft-annotated streaming image on a visual display in a cockpit of the aircraft.

20. A computer system comprising one or more processors and memory storing instructions that, when executed by the one or more processors, cause the one or more processors to:
receive, from a camera on the aircraft, a streaming image from the aircraft;
receive navigation information representative of the location and orientation of the aircraft;
receive surrounding aircraft information associated with each of one or more surrounding aircraft;
determine, based upon the navigation information and the surrounding aircraft information, a location of each of the one or more surrounding aircraft with respect to the streaming image;
generate a surrounding aircraft identifier for each of the one or more surrounding aircraft;
generate a surrounding aircraft-annotated streaming image based upon the streaming image and including each surrounding aircraft identifier, wherein each surrounding aircraft identifier is at a location in the surrounding aircraft-annotated streaming image corresponding to the location of the associated surrounding aircraft; and
display the surrounding aircraft-annotated streaming image in the aircraft.
